(19) United States
(12) Patent Application Publication
(10) Pub. No.: US 2026/0018135 A1
(43) Pub. Date: Jan. 15, 2026

(54) DISPLAY DEVICE AND ELECTRONIC DEVICE INCLUDING THE SAME

(71) Applicant: Samsung Display Co., Ltd., Yongin-si (KR)

(72) Inventors: Dong Hee SHIN, Yongin-si (KR); Kyung Ho KIM, Yongin-si (KR)

(21) Appl. No.: 19/264,508

(22) Filed: Jul. 9, 2025

(30) Foreign Application Priority Data
Jul. 11, 2024 (KR) 10-2024-0091889

(51) Int. Cl. G09G 3/3266; G09G 3/3233

(52) U.S. Cl. CPC G09G 3/3266; G09G 3/3233; G09G 2300/0819; G09G 2300/0852; G09G 2300/0861; G09G 2310/0286

(57) ABSTRACT

A display device includes a first scan driver including first scan stages dependently connected to each other and a first clock signal line connected to each of the first scan stages; and a second scan driver including second scan stages dependently connected to each other and a second clock signal line connected to each of the second scan stages, wherein a first circuit element constituting the first scan stages and a second circuit element constituting the second scan stages are positioned to overlap with each other, and wherein the first clock signal line and the second clock signal line are positioned not to overlap with each other.

### CROSS-REFERENCE TO RELATED APPLICATION

The present application claims priority to and the benefit of Korean Patent Application No. 10-2024-0091889, filed on Jul. 11, 2024, in the Korean Intellectual Property Office, the entire disclosure of which is incorporated herein by reference.

### BACKGROUND

### 1. Field

Aspects of embodiments of the present disclosure generally relate to a display device and an electronic device including the same.

### 2. Description of the Related Art

A display device is a device which displays an image by combining lights emitted from a plurality of pixels. The display device includes a scan driver which outputs scan signals for driving the plurality of pixels.

In general, it is difficult for the pixels to be disposed in an area in which the scan driver is disposed. The area in which the scan driver is disposed may be referred to as a bezel.

Meanwhile, various studies for improving the use convenience of the display device by reducing the area of the bezel have been conducted.

The above information disclosed in this Background section is only for enhancement of understanding of the background of the invention and therefore it may contain information that does not form the prior art.

### SUMMARY

Aspects of some embodiments of the present disclosure are directed to a display device capable of implementing a narrow bezel.

According to some embodiments of the present disclosure, there is provided a display device including: a first scan driver including first scan stages dependently connected to each other and a first clock signal line connected to each of the first scan stages; and a second scan driver including second scan stages dependently connected to each other and a second clock signal line connected to each of the second scan stages, wherein a first circuit element constituting the first scan stages and a second circuit element constituting the second scan stages are positioned to overlap with each other, and wherein the first clock signal line and the second clock signal line are positioned not to overlap with each other.

In some embodiments, the first and second circuit elements may each be positioned not to overlap with the first and second clock signal lines.

In some embodiments, the second circuit element may be on the first circuit element.

In some embodiments, the first circuit element may be implemented with a first circuit element layer including a first lower conductive layer, a first oxide semiconductor layer, a first gate conductive layer, and a first source-drain (SD) conductive layer, which may be sequentially stacked on a substrate, and the second circuit element may be implemented with a second circuit element layer including a second lower conductive layer, a second oxide semiconductor layer, a second gate conductive layer, and a second source-drain (SD) conductive layer, which may be sequentially stacked on the first circuit element layer.

In some embodiments, the display device may further include a driving power line implemented with an intermediate circuit element layer. The intermediate circuit element layer may include an intermediate conductive layer and may be between the first circuit element layer and the second circuit element layer.

In some embodiments, on a section of the display device, the driving power line may be between the first circuit element and the second circuit element.

In some embodiments, the driving power line may be electrically connected to the first circuit element and the second circuit element.

In some embodiments, the first clock signal line may include: a first lower clock signal line implemented with the first SD conductive layer; and a first upper clock signal line implemented with the intermediate conductive layer, the first upper clock signal line being connected to the first lower clock signal line, and the second clock signal line may include: a second lower clock signal line implemented with the intermediate conductive layer; and a second upper clock signal line implemented with the second SD conductive layer.

In some embodiments, the first clock signal and the second clock signal line may be in a first line area, and the first scan stages and the second scan stages may be in a first circuit element area adjacent to the first line area in a first direction.

In some embodiments, the first line area may include a (1-1)th line area and a (1-2)th line area adjacent to the (1-1)th line area in the first direction, the first clock signal line may be in the (1-1)th line area, and the second clock signal line may be in the (1-2)th line area.

In some embodiments, the display device may further include a third scan driver including third scan stages dependently connected to each other and a third clock signal line connected to each of the third scan stages; and a fourth scan driver including fourth scan stages dependently connected to each other and a fourth clock signal line connected to each of the fourth scan stages.

In some embodiments, a third circuit element constituting the third scan stages and a fourth circuit element constituting the fourth scan stages may be positioned to overlap with each other, and the third clock signal line and the fourth clock signal line may be positioned not to overlap with each other.

In some embodiments, the third clock signal line and the fourth clock signal line may be in a second line area adjacent to the first circuit element area in the first direction, and the third scan stages and the fourth scan stages may be in a second circuit element area adjacent to the second line area in the first direction.

In some embodiments, the second line area may include a (2-1)th line area and a (2-2)th line area adjacent to the (2-1)th line area in the first direction, the third clock signal line may be in the (2-1)th line area, and the fourth clock signal line may be in the (2-2)th line area.

In some embodiments, the display device may further include a fifth scan driver including fifth scan stages dependently connected to each other and a fifth clock signal line connected to each of the fifth scan stages.

In some embodiments, the fifth clock signal line may be positioned not to overlap with the first and second clock signal lines and the first, second, and fifth scan stages.

In some embodiments, the fifth scan stages may be positioned not to overlap with the first and second clock signal lines and the first and second scan stages.

In some embodiments, the fifth scan stages may include a fifth lower circuit element and a fifth upper circuit element that overlap each other.

In some embodiments, the fifth lower circuit element may be implemented with a first circuit element layer including a first lower conductive layer, a first oxide semiconductor layer, a first gate conductive layer, and a first SD conductive layer, which may be sequentially stacked on a substrate, and the fifth upper circuit element may be implemented with a second circuit element layer including a second lower conductive layer, a second oxide semiconductor layer, a second gate conductive layer, and a second SD conductive layer, which may be sequentially stacked on the first circuit element layer.

In some embodiments, the fifth upper circuit element and the fifth lower circuit element may be electrically connected to each other.

According to some embodiments of the present disclosure there is provided an electronic device including: a display device, wherein the display device includes: a first scan driver including first scan stages dependently connected to each other and a first clock signal line connected to each of the first scan stages; and a second scan driver including second scan stages dependently connected to each other and a second clock signal line connected to each of the second scan stages, wherein a first circuit element constituting the first scan stages and a second circuit element constituting the second scan stages are positioned to overlap with each other, and wherein the first clock signal line and the second clock signal line are positioned not to overlap with each other.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a display device according to some embodiments of the present disclosure.

FIGS. 2 and 3 are diagrams illustrating a pixel according to some embodiments of the present disclosure.

FIG. 4 is a diagram illustrating a first scan driver according to some embodiments of the present disclosure.

FIG. 5 is a diagram illustrating a second scan driver according to some embodiments of the present disclosure.

FIG. 6 is a diagram illustrating a third scan driver according to some embodiments of the present disclosure.

FIG. 7 is a diagram illustrating a fourth scan driver according to some embodiments of the present disclosure.

FIG. 8 is a diagram illustrating a fifth scan driver according to some embodiments of the present disclosure.

FIGS. 9 to 14 are diagrams illustrating a scan driver according to some embodiments of the present disclosure.

FIGS. 15 to 18 are diagrams illustrating a scan driver according to some embodiments of the present disclosure.

FIG. 19 is a block diagram of an electronic device according to some embodiments of the present disclosure.

FIG. 20 shows schematic views of various embodiments of an electronic device.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

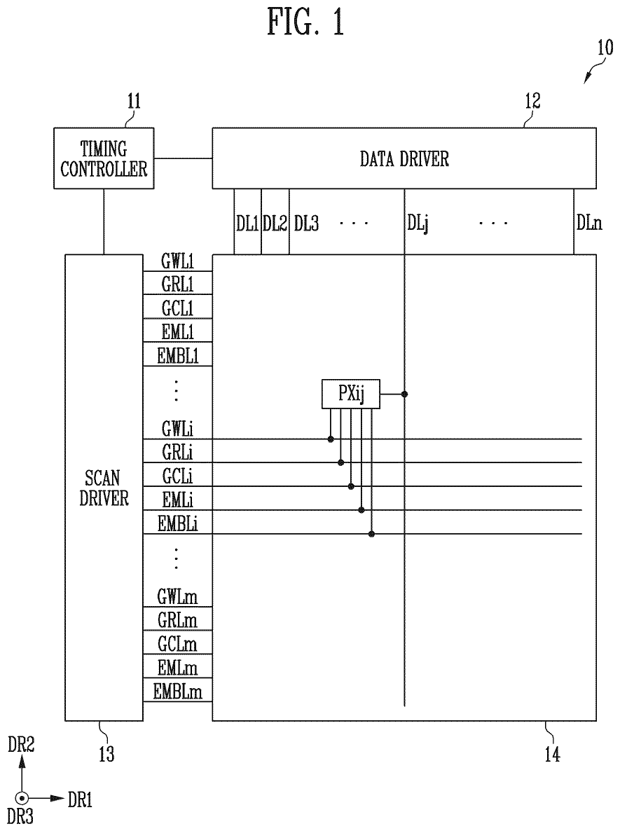

FIG. 1 is a diagram illustrating a display device according to some embodiments of the present disclosure.

Referring to FIG. 1, the display device 10 may include a timing controller 11, a data driver 12, a scan driver 13, and a pixel unit 14.

The timing controller 11 may receive grayscales for an image (e.g., a frame). The grayscales may include a first color grayscale, a second color grayscale, and a third color grayscale. The first color grayscale may be a grayscale for expressing a first color, the second color grayscale may be a grayscale for expressing a second color, and the third color grayscale may be a grayscale for expressing a third color.

The timing controller 11 may receive a control signal for the image. The control signal may include a horizontal synchronization signal, a vertical synchronization signal, and a data enable signal. The vertical synchronization signal may include a plurality of pulses, and may indicate that a previous frame period is ended and a current frame period is started with respect to a time at which each of the pulses is generated. An interval between adjacent pulses of the vertical synchronization signal may correspond to one frame period. The horizontal synchronization signal may include a plurality of pulses, and may indicate that a previous horizontal period is ended and a new horizontal period is started with respect to a time at which each of the pulses is generated. An interval between adjacent pulses of the horizontal synchronization signal may correspond to one horizontal period. The data enable signal may have an enable level with respect to specific horizontal periods and have a disable level in the other periods. When the data enable signal is at the enable level, color grayscales may be supplied in corresponding periods.

As used herein, “an enable level” of a signal may refer to a voltage level sufficient to activate/turn on a transistor to which the signal is applied, and “a disable level” of the signal may refer to a voltage level that can deactivate/turn off a transistor to which the signal is applied. For example, when the signal is applied to a gate of an N-channel Metal-Oxide-Semiconductor (NMOS) transistor, the “enable level” may refer to a voltage greater than or equal to the threshold voltage (Vth) of the NMOS transistor, and the “disable level” may refer to a voltage less than the threshold voltage (Vth) of the NMOS transistor. The levels may be reversed when the signal is applied to a P-channel Metal-Oxide-Semiconductor (PMOS) transistor.

The timing controller 11 may provide the data driver 12 with grayscales rendered or corrected to be suitable for specifications of the display device 10. Also, the timing controller 11 may provide the scan driver 13 with a clock signal, a scan start signal, and the like.

The data driver 12 may generate data voltages to be provided to data lines DL1, DL2, DL3, . . . , DLj, . . . , and DLn, using grayscales and control signals, which are received from the timing controller 11. For example, the data driver 12 may sample grayscales, using a clock signal, and apply data voltages corresponding to the grayscales to the data lines DL1 to DLn in units of pixel rows. Here, j and n may be integers larger (e.g., greater) than 0, with n being greater than j. A pixel row may mean pixels connected to the same scan line.

The scan driver 13 may generate scan signals to be provided to scan lines GWL1, GRL1, GCL1, EML1, EMBL1, . . . , GWLi, GRLi, GCLi, EMLi, EMBLi, . . . GWLm, GRLm, GCLm, EMLm, and EMBLm by receiving a clock signal, a scan start signal, and the like from the timing controller 11. Here, i and m may be integers greater than 0, with m may be greater than i. For example, the scan driver 13 may include a first scan driver connected to first scan lines EMBL1, . . . , EMBLi, . . . , and EMBLm, a second scan driver connected to second scan lines GRL1, . . . , GRLi, . . . , and GRLm, a third scan driver connected to third scan lines GCL1, . . . , GCLi, . . . , and GCLm, a fourth scan driver connected to fourth scan lines EML1, . . . , EMLi, . . . , and EMLm, and a fifth scan driver connected to fifth scan lines GWL1, . . . , GWLi, . . . , and GWLm.

In some embodiments, the scan lines GWL1, GRL1, GCL1, EML1, EMBL1, . . . , GWLi, GRLi, GCLi, EMLi, EMBLi, . . . GWLm, GRLm, GCLm, EMLm, and EMBLm may extend in a first direction DR1, and the data lines DL1, DL2, DL3, . . . , DLj, . . . and DLn may extend in a second direction DR2 intersecting the first direction DR1. A direction perpendicular to the first and second directions DR1 and DR2 may be a third direction DR3.

In some embodiments, the first scan driver may sequentially provide scan signals having a pulse of a turn-on level to the first scan lines EMBL1 to EMBLm. For example, the first scan driver may be configured in the form of a shift register, and may generate scan signals in a manner that sequentially transfers the scan start signal in the form of a pulse of a turn-on level to a next stage circuit under the control of the clock signal. The second to fifth scan drivers may also be substantially implemented in the same manner as the first scan driver.

The pixel unit 14 may include pixels. Each pixel PXij may be connected to a corresponding data line and a corresponding scan line. Here, each of i and j may be an integer greater than 0. The pixel PXij may mean a pixel connected to an ith scan line and a jth data line.

The pixel unit 14 may include first pixels emitting light of the first color, second pixels emitting light of the second color, and third pixels emitting light of the third color. The first color, the second color, and the third color may be different colors. For example, the first color may be one color among red, green, and blue, the second color may be another color different from the first color among red, green, and blue, and the third color may be the other color different from the first color and the second color among red, green, and blue. For example, magenta, cyan, and yellow instead of red, green, and blue may be used as the first to third colors.

The pixels of the pixel unit 14 may be arranged in various forms, such as diamond PENTILE™, RGB-stripe, S-strip, real RGB, and normal PENTILE™.

An area in which the pixels are disposed in the pixel unit 14 may be referred to as a display area. An area except the display area (e.g., an area different from the display area or an area around the display area) in the display device 10 may be referred to as a non-display area.

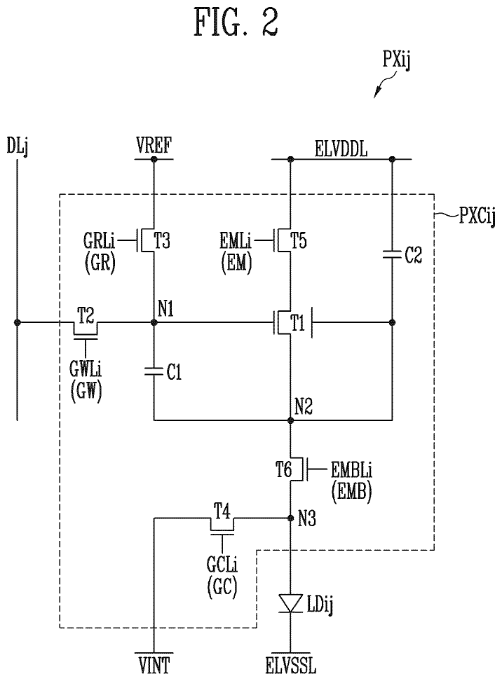

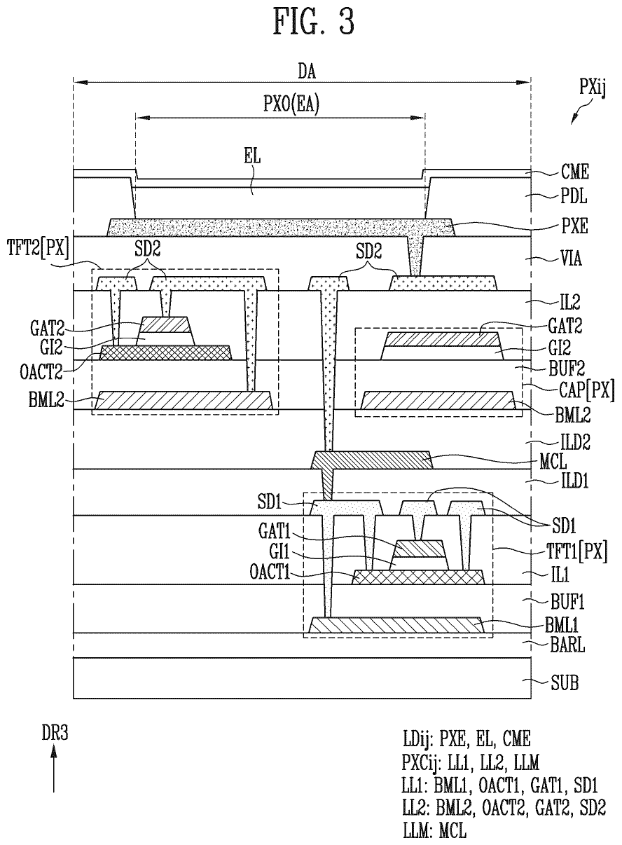

FIGS. 2 and 3 are diagrams illustrating a pixel according to some embodiments of the present disclosure.

Referring to FIG. 2, the pixel PXij may include a pixel circuit PXCij and a light emitting element LDij connected to the pixel circuit PXCij. The pixel circuit PXCij may include transistors T1, T2, T3, T4, T5, and T6, a first capacitor C1, and a second capacitor C2.

Hereinafter, a circuit implemented with an N-type transistor is described as an example. However, those skilled in the art may design a circuit implemented with a P-type transistor by changing the polarity of a voltage applied to a gate electrode. Similarly, those skilled in the art may design a circuit implemented with a combination of the P-type transistor and the N-type transistor. The P-type transistor is commonly called a transistor in which an amount of current flowing therethrough increases when a difference in voltage between a gate terminal and a source terminal increases in a negative direction. The N-type transistor is commonly called a transistor in which an amount of current flowing therethrough increases when a difference in voltage between a gate terminal and a source terminal increases in a positive direction. The transistor may be configured in various forms including a Thin Film Transistor (TFT), a Field Effect Transistor (FET), a Bipolar Junction Transistor (BJT), and the like.

Hereinafter, some embodiments are described, in which the transistors T1, T2, T3, T4, T5, and T6 is implemented with an N-type oxide thin film transistor. The oxide thin film transistor may be a low temperature polycrystalline oxide (LTPO) thin film transistor in which a semiconductor layer includes oxide. However, this is merely illustrative, and N-type transistors are not limited thereto. For example, a semiconductor layer included in the N-type transistor may include an inorganic semiconductor (e.g., amorphous silicon or poly-silicon), an organic semiconductor, or the like.

A first gate electrode of a first transistor T1 may be connected to a first node N1, and a second gate electrode of the first transistor T1 may be connected to a second node N2. The second gate electrode of the first transistor T1 may be used to adjust a characteristic of an output current to an input voltage. For example, the first transistor T1 may mainly operate in a saturation state. When the second gate electrode of the first transistor T1 does not exist (e.g., is omitted), the magnitude of the output current may vary according to a change in drain-source voltage in spite of the same gate-source voltage. In accordance with these embodiments, the characteristic of the first transistor T1 may be adjusted to be insensitive to the change in drain-source voltage, so that the first transistor T1 can substantially output the same current with respect to the same gate-source voltage. The first transistor T1 may control an amount of driving current flowing from a first power line ELVDDL to a second power line ELVSSL. Therefore, the first transistor T1 may be referred to as a driving transistor. A first electrode of the first transistor T1 may be connected to a second electrode of a fifth transistor T5, and a second electrode of the first transistor T1 may be connected to the second node N2.

A gate electrode of a second transistor T2 may be connected to a fifth scan line GWLi to receive a fifth scan signal GW, a first electrode of the second transistor T2 may be connected to a data line DLj, and a second electrode of the second transistor T2 may be connected to the first node N1. The second transistor T2 may receive a data voltage applied to the data line DLj. Therefore, the second transistor T2 may be referred to as a write transistor.

A gate electrode of a third transistor T3 may be connected to a second scan line GRLi to receive a second scan signal GR, a first electrode of the third transistor T3 may receive a reference voltage VREF, and a second electrode of the third transistor T3 may be connected to the first node N1. The reference voltage VREF may be supplied from a reference voltage source. The third transistor T3 may initialize a voltage of the first node N1 to the reference voltage VREF by applying the reference voltage VREF to the first node N1. Therefore, the third transistor T3 may be referred to as a first initialization transistor.

A gate electrode of a fourth transistor T4 may be connected to a third scan line GCLi to receive a third scan signal GC, a first electrode of the fourth transistor T4 may receive an initialization voltage VINT, and a second electrode of the fourth transistor T4 may be connected to a third node N3. The initialization voltage VINT may be supplied from an initialization voltage source. The fourth transistor T4 may initialize a voltage of the third node N3 to the initialization voltage VINT by applying the initialization voltage VINT to the third node N3. Therefore, the fourth transistor T4 may be referred to as a second initialization transistor.

A gate electrode of the fifth transistor T5 may be connected to a fourth scan line EMLi to receive a fourth scan signal EM, a first electrode of the fifth transistor T5 may be connected to the first power line ELVDDL, and the second electrode of the fifth transistor T5 may be connected to the first electrode of the first transistor T1. The fifth transistor T5 may control opening/closing of a driving current path connected from the first power line ELVDDL to the second power line ELVSSL. Therefore, the fifth transistor T5 may be referred to as a first emission control transistor.

A gate electrode of a sixth transistor T6 may be connected to a first scan line EMBLi to receive a first scan signal EMB, a first electrode of the sixth transistor T6 may be connected to the second node N2, and a second electrode of the sixth transistor T6 may be connected to the third node N3. The sixth transistor T6 may control opening/closing of the driving current path connected to the first power line ELVDDL to the second power line ELVSSL. Therefore, the sixth transistor T6 may be referred to as a second emission transistor.

The first capacitor C1 may be connected between the first node N1 and the second node N2. The second capacitor C2 may be connected between the first power line ELVDDL and the second node N2.

An anode electrode of the light emitting element LDij may be connected to the third node N3, and a cathode electrode of the light emitting element LDij may be connected to the second power line ELVSSL. The light emitting element LDij may be a light emitting diode. The light emitting element LDij may be configured as an organic light emitting diode, an inorganic light emitting diode, a quantum dot/well light emitting diode, or the like. In some embodiments, the pixel PXij may include one light emitting element LDij. In some other embodiments, the pixel PXij may include a plurality of light emitting elements. The plurality of light emitting elements may be connected in series, parallel, series/parallel, or the like. The light emitting element LDij may emit light of one each of a first color, a second color, and a third color.

Referring to FIG. 3, the pixel PXij may include a substrate SUB, a barrier layer BARL, a first lower conductive layer BML1, a first buffer layer BUF1, a first oxide semiconductor layer OACT1, a first gate insulating layer GI1, a first gate conductive layer GAT1, a first insulating layer IL1, a first source-drain (SD) conductive layer SD1, a first interlayer insulating layer ILD1, an intermediate conductive layer MCL, a second interlayer insulating layer ILD2, a second lower conductive layer BML2, a second buffer layer BUF2, a second oxide semiconductor layer OACT2, a second gate insulating layer GI2, a second gate conductive layer GAT2, a second insulating layer IL2, a second SD conductive layer SD2, a via insulating layer VIA, a pixel electrode layer PXE, a pixel defining layer PDL, an organic light emitting layer EL, and a common electrode layer CME, which are sequentially stacked in the third direction DR3 (e.g., a thickness direction).

The substrate SUB may be made of various materials including glass, polymer, metal, and/or the like. The substrate SUB may be rigid or flexible according to applied products.

The first oxide semiconductor layer OACT1 and the second oxide semiconductor layer OACT2 may include an oxide semiconductor. The first oxide semiconductor layer OACT1 and the second oxide semiconductor layer OACT2 may define a channel and an electrode of a transistor.

Each of the first lower conductive layer BML1, the first gate conductive layer GAT1, the first SD conductive layer SD1, the intermediate conductive layer MCL, the second lower conductive layer BML2, the second gate conductive layer GAT2, and the second SD conductive layer SD2 may be independently configured as a single layer or a multi-layer (e.g., a structure having more than one layer), and be configured using a conductor such as gold (Au), silver (Ag), aluminum (Al), molybdenum (Mo), chromium (Cr), titanium (Ti), nickel (Ni), neodymium (Nd), copper (Cu), platinum (Pt), and/or the like.

The barrier layer BARL, the first buffer layer BUF1, the first gate insulating layer GI1, the first insulating layer IL1, the first interlayer insulating layer ILD1, the second interlayer insulating layer ILD2, the second buffer layer BUF2, the second gate insulating layer GI2, the second insulating layer IL2, and the via insulating layer VIA may be interposed to electrically separate the first lower conductive layer BML1, the first oxide semiconductor layer OACT1, the first gate conductive layer GAT1, the first SD conductive layer SD1, the intermediate conductive layer MCL, the second lower conductive layer BML2, the second oxide semiconductor layer OACT2, the second gate conductive layer GAT2, and the second SD conductive layer SD2 from each other. If necessary, electrode patterns (or semiconductor patterns) implemented with conductive layers (or semiconductor layers) may be connected to each other through a penetration hole formed in each of the insulating layers BARL, BUF1, GI1, IL1, ILD1, ILD2, BUF2, GI2, IL2, and VIA. The insulating layers BARL, BUF1, GI1, IL1, ILD1, ILD2, BUF2, GI2, IL2, and VIA may include an inorganic insulating material and/or an organic insulating material. For example, the insulating layers BARL, BUF1, GI1, IL1, ILD1, ILD2, BUF2, GI2, IL2, and VIA may include silicon oxide, silicon nitride, silicon oxynitride, epoxy resin, a phenolic resin, polyamide resin, polyimide resin, and/or the like.

The first lower conductive layer BML1, the first oxide semiconductor layer OACT1, the first gate conductive layer GAT1, the first SD conductive layer SD1, the intermediate conductive layer MCL, the second lower conductive layer BML2, the second oxide semiconductor layer OACT2, the second gate conductive layer GAT2, and the second SD conductive layer SD2 may define pixel circuit elements constituting the pixel circuit PXCij.

In some embodiments, a first circuit element layer LL1 may be defined, which includes the first lower conductive layer BML1, the first oxide semiconductor layer OACT1, the first gate conductive layer GAT1, and the first SD conductive layer SD1. Various electrode patterns and various semiconductor patterns, which are implemented by the layers BML1, OACT1, GAT1, and SD1 included in the first circuit element layer LL1, may define a first pixel transistor TFT1[PX]. For example, as shown in FIG. 3, a semiconductor pattern implemented with the first oxide semiconductor layer OACT1 may define a channel and an electrode of the first pixel transistor TFT1[PX], and an electrode pattern implemented with the first gate conductive layer GAT1 may define a gate electrode of the first pixel transistor TFT1[PX]. Electrode patterns (or line patterns) implemented with the first lower conductive layer BML1 and the first SD conductive layer SD1 may define a bottom gate electrode of the first pixel transistor TFT1[PX], electrodes, and lines connecting the same to each other.

In some embodiments, a second circuit element layer LL2 may be defined, which includes the second lower conductive layer BML2, the second oxide semiconductor layer OACT2, the second gate conductive layer GAT2, and the second SD conductive layer SD2. Various electrode patterns (or line patterns) and various semiconductor patterns, which are implemented by the layers BML2, OACT2, GAT2, and SD2 included in the second circuit element layer LL2, may define a second pixel transistor TFT2[PX] and a pixel capacitor CAP[PX].

In some embodiments, an intermediate circuit element layer LLM including the intermediate conductive layer MCL may be defined. Various electrode patterns (or line patterns) implemented by the intermediate conductive layer MCL may be connected to at least one of the first and second pixel transistors TFT1[PX] and TFT2[PX] and the pixel capacitor CAP[PX], which are described above, to serve as an electrode (or line).

The first and second pixel transistors TFT1[PX] and TFT2[PX] may correspond to two transistors among the first to sixth transistors T1, T2, T3, T4, T5, and T6 which have been described with reference to FIG. 2. The pixel capacitor CAP[PX] may correspond to any one of the first and second capacitors C1 and C2 which have been described with reference to FIG. 2. As such, various circuit elements constituting the pixel circuit PXCij may be implemented by the first circuit element layer LL1, the second circuit element layer LL2, and the intermediate circuit element layer LLM. The pixel circuit PXCij may include the first circuit element layer LL1, the second circuit element layer LL2, and the intermediate circuit element LLM.

The pixel electrode layer PXE may be disposed on the via insulating layer VIA. The pixel electrode layer PXE may be connected to the second SD conductive layer SD2 through a penetration hole penetrating the via insulating layer VIA. Accordingly, the pixel electrode layer PXE may be electrically connected to various circuit elements constituting the pixel circuit PXCij. In some embodiments, the anode electrode of light emitting element LDij may be implemented with the pixel electrode layer PXE.

The pixel defining layer PDL may be disposed on the via insulating layer VIA and the pixel electrode layer PXE. The pixel defining layer PDL may include a pixel opening PXO exposing at least a portion of the anode electrode.

The organic light emitting layer EL may be disposed on the anode electrode exposed by the pixel opening PXO. The organic light emitting layer EL may include an organic light emitting material suitable for generating light.

The common electrode layer CME may be disposed on the organic light emitting layer EL. The common electrode layer CME may include a transparent or translucent conductive material to satisfy (e.g., provide) a set light transmittance (e.g., a preset or predetermined light transmittance). In some embodiments, the cathode electrode of the light emitting element LDij may be implemented with the common electrode CME.

A portion of the pixel electrode layer PXE, which is exposed by the pixel opening PXO, a portion of the organic light emitting layer EL, which overlaps with the portion of the pixel electrode layer PXE, and a portion of the common electrode layer CME, which overlaps with the portion of the organic light emitting layer EL, may define the light emitting element LDij. An area in which light is substantially emitted in the light emitting element LDij may be an emission area EA. In some embodiments, the emission area EA may be an area substantially identical (e.g., similar) to an area defined by the pixel opening PXO.

An area in which the pixel PXij is disposed may be referred to as a display area DA. The display area DA may be, for example, an area corresponding to the pixel unit 14 shown in FIG. 1.

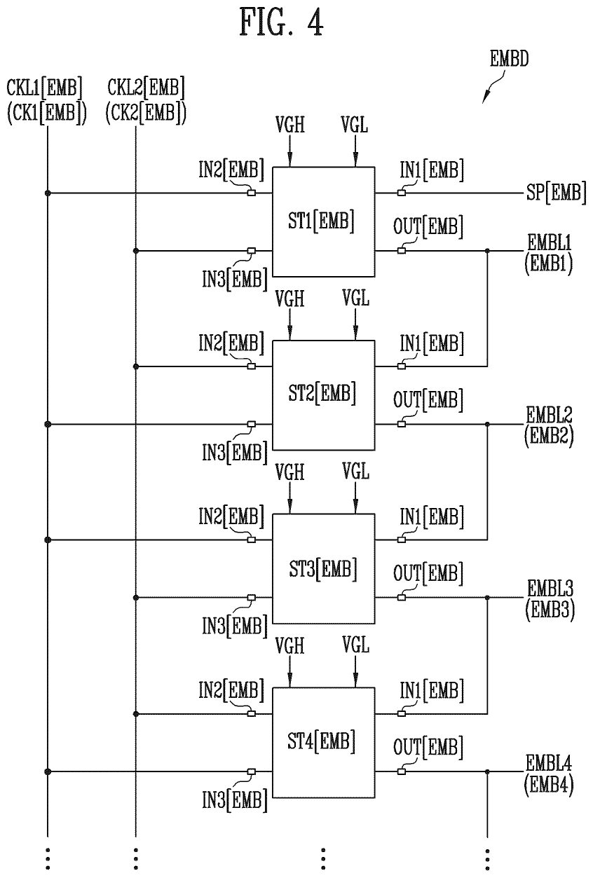

FIG. 4 is a diagram illustrating a first scan driver according to some embodiments of the present disclosure.

Referring to FIG. 4, the first scan driver EMBD may include first scan stages for supplying the first scan signal EMB to the first scan lines EMBL1, . . . , EMBLi, . . . , and EMBLm which have been described with reference to FIG. 1. The first scan stages may be dependently connected to each other, and sequentially output the first scan signal EMB.

For clear and brief description, only a (1-1)th scan stage ST1[EMB], a (1-2)th scan stage ST2[EMB], a (1-3)th scan stage ST3[EMB], and a (1-4)th scan stage ST4[EMB] among the first scan stages are illustrated in FIG. 4. Hereinafter, the first scan driver EMBD will be described based on the (1-1)th scan stage ST1[EMB], the (1-2)th scan stage ST2[EMB], the (1-3)th scan stage ST3[EMB], and the (1-4)th scan stage ST4[EMB].

The (1-1)th scan stage ST1[EMB], the (1-2)th scan stage ST2[EMB], the (1-3)th scan stage ST3[EMB], and the (1-4)th scan stage ST4[EMB] may be dependently connected to an input terminal of a first start pulse SP[EMB](e.g., a first input terminal IN1[EMB] of the (1-1)th scan stage ST1[EMB]).

The (1-1)th scan stage ST1[EMB], the (1-2)th scan stage ST2[EMB], the (1-3)th scan stage ST3[EMB], and the (1-4)th scan stage ST4[EMB] may be connected to a (1-1)th scan line EMBL1, a (1-2)th scan line EMBL2, a (1-3)th scan line EMBL3, and a (1-4)th scan line EMBL4, respectively.

The (1-1)th scan stage ST1[EMB], the (1-2)th scan stage ST2[EMB], the (1-3)th scan stage ST3[EMB], and the (1-4)th scan stage ST4[EMB] may be connected to a (1-1)th clock signal line CKL1[EMB]transferring a (1-1)th clock signal CK1[EMB] and a (1-2)th clock signal line CKL2[EMB]transferring a (1-2)th clock signal CK2[EMB].

The (1-1)th scan stage ST1[EMB], the (1-2)th scan stage ST2[EMB], the (1-3)th scan stage ST3[EMB], and the (1-4)th scan stage ST4[EMB] may generate a (1-1)th scan signal EMB1, a (1-2)th scan signal EMB2, a (1-3)th scan signal EMB3, and a (1-4)th scan signal EMB4, respectively, using the (1-1)th clock signal CK1[EMB] and the (1-2)th clock signal CK2[EMB].

The (1-1)th scan stage ST1[EMB], the (1-2)th scan stage ST2[EMB], the (1-3)th scan stage ST3[EMB], and the (1-4)th scan stage ST4[EMB] may sequentially output the (1-1)th scan signal EMB1, the (1-2)th scan signal EMB2, the (1-3)th scan signal EMB3, and the (1-4)th scan signal EMB4 to the (1-1)th scan line EMBL1, the (1-2)th scan line EMBL2, the (1-3)th scan line EMBL3, and the (1-4)th scan line EMBL4. In accordance with some embodiments, the first scan stages may substantially have the same circuit structure.

Each of the scan stages may include a first input terminal IN1[EMB], a second input terminal IN2[EMB], a third input terminal IN3[EMB], and an output terminal OUT[EMB].

The first input terminal IN1[EMB] may be supplied with a first input signal. The first input signal may be the first start pulse SP[EMB] or an output signal of a previous first scan stage (i.e., a first scan signal of the previous first scan stage). For example, the (1-1)th scan stage ST1[EMB] may be supplied with the first start pulse SP[EMB] through the first input terminal IN1[EMB], and each of the other first scan stages may be supplied with an output signal of a previous first scan stage through a first input terminal IN1[EMB] thereof.

The second input terminal IN2[EMB] and the third input terminal IN3[EMB] may be supplied with a second input signal and a third input signal, respectively. In some embodiments, a second input signal and a third input signal of an odd-numbered first scan stage may be the (1-1)th clock signal CK1[EMB] and the (1-2)th clock signal CK2[EMB], respectively. For example, a second input signal and a third input signal of an even-numbered first scan stage may be the (1-2)th clock signal CK2[EMB] and the (1-1)th clock signal CK1[EMB], respectively. For example, a second input terminal IN2[EMB] of the (1-1)th scan stage ST1[EMB] may be connected to the (1-1)th clock signal line CKL1[EMB] to be supplied with the (1-1)th clock signal CK1[EMB], and a third input terminal IN3[EMB] of the (1-1)th scan stage ST1[EMB] may be connected to the (1-2)th clock signal line CKL2[EMB] to be supplied with the (1-2)th clock signal CK2[EMB]. A second input terminal IN2[EMB] of the (1-2)th scan stage ST2[EMB] may be connected to the (1-2)th clock signal line CKL2[EMB] to be supplied with the (1-2)th clock signal CK2[EMB], and a third input terminal IN3[EMB] of the (1-2)th scan stage ST2[EMB] may be connected to the (1-1)th clock signal line CKL1[EMB] to be supplied with the (1-1)th clock signal CK1[EMB].

The (1-1)th clock signal CK1[EMB] and the (1-2)th clock signal CK2[EMB] may alternately (e.g., in an alternating manner) have a gate-on voltage. For example, the (1-1)th clock signal CK1[EMB] and the (1-2)th clock signal CK2[EMB] may be signals which have the same cycle and have phases not overlapping with each other. For example, the (1-2)th clock signal CK2[EMB] may be a clock signal obtained by shifting the (1-1)th clock signal CK1[EMB] by a half cycle.

For example, the first scan stages may be supplied with a first driving power source VGH and a second driving power source VGL to operate. A voltage of the first driving power source VGH may be set as a gate-high voltage, and a voltage of the second driving power source VGL may be set as a gate-low voltage.

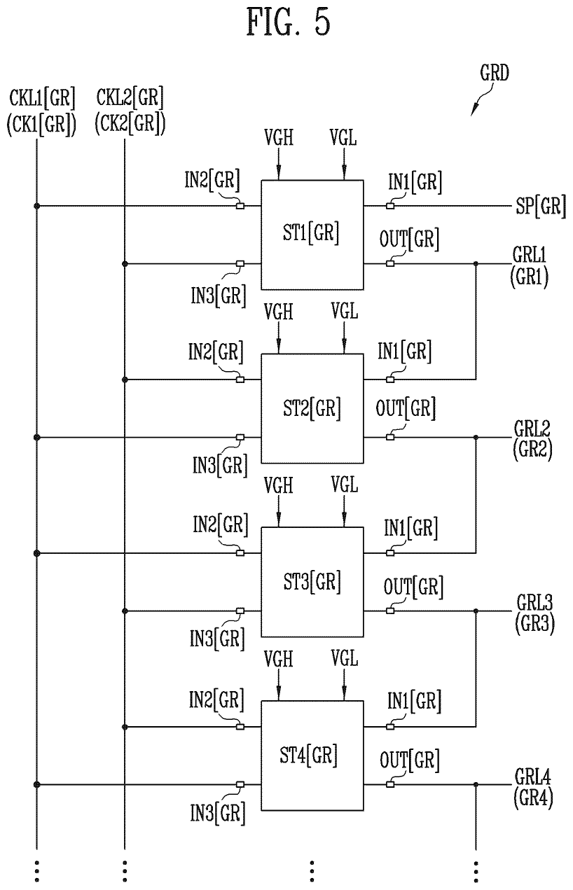

FIG. 5 is a diagram illustrating a second scan driver according to some embodiments of the present disclosure.

Referring to FIG. 5, the second scan driver GRD may include second scan stages for supplying the second scan signal GR to the second scan lines GRL1, . . . , GRLi, . . . , and GRLm which have been described with reference to FIG. 1. The second scan stages may be dependently connected to each other, and sequentially output the second scan signal GR.

For clear and brief description, only a (2-1)th scan stage ST1[GR], a (2-2)th scan stage ST2[GR], a (2-3)th scan stage ST3[GR], and a (2-4)th scan stage ST4[GR] among the second scan stages are illustrated in FIG. 5. Hereinafter, the second scan driver GRD will be described based on the (2-1)th scan stage ST1[GR], the (2-2)th scan stage ST2[GR], the (2-3)th scan stage ST3[GR], and the (2-4)th scan stage ST4[GR].

The (2-1)th scan stage ST1[GR], the (2-2)th scan stage ST2[GR], the (2-3)th scan stage ST3[GR], and the (2-4)th scan stage ST4[GR] may be dependently connected to an input terminal of a second start pulse SP[GR](e.g., a first input terminal IN1[GR] of the (2-1)th scan stage ST1[GR]).

The (2-1)th scan stage ST1[GR], the (2-2)th scan stage ST2[GR], the (2-3)th scan stage ST3[GR], and the (2-4)th scan stage ST4[GR] may be connected to a (2-1)th scan line GRL1, a (2-2)th scan line GRL2, a (2-3)th scan line GRL3, and a (2-4)th scan line GRL4, respectively.

The (2-1)th scan stage ST1[GR], the (2-2)th scan stage ST2[GR], the (2-3)th scan stage ST3[GR], and the (2-4)th scan stage ST4[GR] may be connected to a (2-1)th clock signal line CKL1[GR]transferring a (2-1)th clock signal CK1[GR] and a (2-2)th clock signal line CKL2[GR]transferring a (2-2)th clock signal CK2[GR].

The (2-1)th scan stage ST1[GR], the (2-2)th scan stage ST2[GR], the (2-3)th scan stage ST3[GR], and the (2-4)th scan stage ST4[GR] may generate a (2-1)th scan signal GR1, a (2-2)th scan signal GR2, a (2-3)th scan signal GR3, and a (2-4)th scan signal GR4, using the (2-1)th clock signal CK1[GR] and the (2-2)th clock signal CK2[GR].

The (2-1)th scan stage ST1[GR], the (2-2)th scan stage ST2[GR], the (2-3)th scan stage ST3[GR], and the (2-4)th scan stage ST4[GR] may sequentially output the (2-1)th scan signal GR1, the (2-2)th scan signal GR2, the (2-3)th scan signal GR3, and the (2-4)th scan signal GR4 to the (2-1)th scan line GRL1, the (2-2)th scan line GRL2, the (2-3)th scan line GRL3, and the (2-4)th scan line GRL4, respectively. In some embodiments, the second scan stages may substantially have the same circuit structure.

Each of the second scan stages may include a first input terminal IN1[GR], a second input terminal IN2[GR], a third input terminal IN3[GR], and an output terminal OUT[GR].

The first input terminal IN1[GR] may be supplied with a first input signal. The first input signal may be the second start pulse SP[GR] or an output signal of a previous second scan stage (i.e., a second scan signal of the previous second scan stage). For example, the (2-1)th scan stage ST1[GR] may be supplied with the second start pulse SP[GR] through the first input terminal IN1[GR], and each of the other second scan stages may be supplied with an output signal of a previous second scan stage through a first input terminal IN1[GR] thereof.

The second input terminal IN2[GR] and the third input terminal IN3[GR] may be supplied with a second input signal and a third input signal, respectively. In some embodiments, a second input signal and a third input signal of an odd-numbered second scan stage may be the (2-1)th clock signal CK1[GR] and the (2-2)th clock signal CK2[GR], respectively. For example, a second input signal and a third input signal of an even-numbered second scan stage may be the (2-2)th clock signal CK2[GR] and the (2-1)th clock signal CK1[GR], respectively.

The (2-1)th clock signal CK1[GR] and the (2-2)th clock signal CK2[GR] may alternately have a gate-on voltage. For example, the (2-1)th clock signal CK1[GR] and the (2-2)th clock signal CK2[GR] may be signals which have the same cycle and have phases not overlapping with each other. For example, the (2-2)th clock signal CK2[GR] may be a clock signal obtained by shifting the (2-1)th clock signal CK1[GR] by a half cycle.

For example, the second scan stages may be supplied with the first driving power source VGH and the second driving power source VGL to operate. The voltage of the first driving power source VGH may be set as a gate-high voltage, and the voltage of the second driving power source VGL may be set as a gate-low voltage.

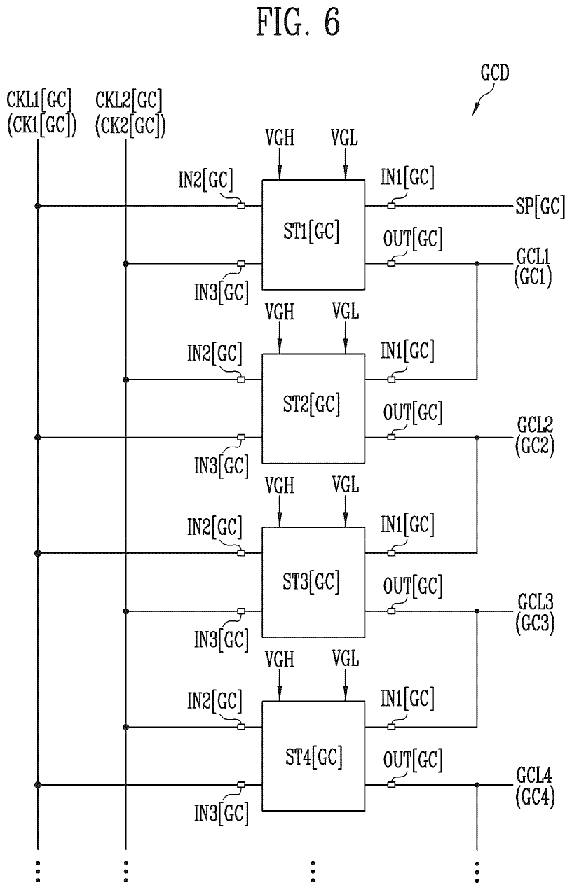

FIG. 6 is a diagram illustrating a third scan driver according to some embodiments of the present disclosure.

Referring to FIG. 6, the third scan driver GCD may include third scan stages for supplying the third scan signal GC to the third scan lines GCL1, . . . , GCLi, . . . , and GCLm which have been described with reference to FIG. 1. The third scan stages may be dependently connected to each other, and sequentially output the third scan signal GC.

For clear and brief description, only a (3-1)th scan stage ST1[GC], a (3-2)th scan stage ST2[GC], a (3-3)th scan stage ST3[GC], and a (3-4)th scan stage ST4[GC] among the third scan stages are illustrated in FIG. 6. Hereinafter, the third scan driver GCD will be described based on the (3-1)th scan stage ST1[GC], the (3-2)th scan stage ST2[GC], the (3-3)th scan stage ST3[GC], and the (3-4)th scan stage ST4[GC].

The (3-1)th scan stage ST1[GC], the (3-2)th scan stage ST2[GC], the (3-3)th scan stage ST3[GC], and the (3-4)th scan stage ST4[GC] may be dependently connected to an input terminal of a third start pulse SP[GC](e.g., a first input terminal IN1[GC] of the (3-1)th scan stage ST1[GC]).

The (3-1)th scan stage ST1[GC], the (3-2)th scan stage ST2[GC], the (3-3)th scan stage ST3[GC], and the (3-4)th scan stage ST4[GC] may be connected to a (3-1)th scan line GCL1, a (3-2)th scan line GCL2, a (3-3)th scan line GCL3, and a (3-4)th scan line GCL4, respectively.

The (3-1)th scan stage ST1[GC], the (3-2)th scan stage ST2[GC], the (3-3)th scan stage ST3[GC], and the (3-4)th scan stage ST4[GC] may be connected to a (3-1)th clock signal line CKL1[GC]transferring a (3-1)th clock signal CK1[GC] and a (3-2)th clock signal line CKL2[GC]transferring a (3-2)th clock signal CK2[GC].

The (3-1)th scan stage ST1[GC], the (3-2)th scan stage ST2[GC], the (3-3)th scan stage ST3[GC], and the (3-4)th scan stage ST4[GC] may generate a (3-1)th scan signal GC1, a (3-2)th scan signal GC2, a (3-3)th scan signal GC3, and a (3-4)th scan signal GC4, respectively, using the (3-1)th clock signal CK1[GC] and the (3-2)th clock signal CK2[GC].

The (3-1)th scan stage ST1[GC], the (3-2)th scan stage ST2[GC], the (3-3)th scan stage ST3[GC], and the (3-4)th scan stage ST4[GC] may sequentially output the (3-1)th scan signal GC1, the (3-2)th scan signal GC2, the (3-3)th scan signal GC3, and the (3-4)th scan signal GC4 to the (3-1)th scan line GCL1, the (3-2)th scan line GCL2, the (3-3)th scan line GCL3, and the (3-4)th scan line GCL4. In some embodiments, the third scan stages may substantially have the same circuit structure.

Each of the third scan stages may include a first input terminal IN1[GC], a second input terminal IN2[GC], a third input terminal IN3[GC], and an output terminal OUT[GC].

The first input terminal IN1[GC] may be supplied with a first input signal. The first input signal may be the third start pulse SP[GC] or an output signal of a previous third scan stage (i.e., a third scan signal of the previous third scan stage). For example, the (3-1)th scan stage ST1[GC] may be supplied with the third start pulse SP[GC] through the first input terminal IN1[GC], and each of the other third scan stages may be supplied with an output signal of a previous third scan stage through a first input terminal IN1[GC] thereof.

The second input terminal IN2[GC] and the third input terminal IN3[GC] may be supplied with a second input signal and a third input signal, respectively. In some embodiments, a second input signal and a third input signal of an odd-numbered third scan stage may be the (3-1)th clock signal CK1[GC] and the (3-2)th clock signal CK2[GC], respectively. For example, a second input signal and a third input signal of an even-numbered third scan stage may be the (3-2)th clock signal CK2[GC] and the (3-1)th clock signal CK1[GC], respectively.

The (3-1)th clock signal CK1[GC] and the (3-2)th clock signal CK2[GC] may alternately have a gate-on voltage. For example, the (3-1)th clock signal CK1[GC] and the (3-2)th clock signal CK2[GC] may be signals which have the same cycle and have phases not overlapping with each other. For example, the (3-2)th clock signal CK2[GC] may be a clock signal obtained by shifting the (3-1)th clock signal CK1[GC] by a half cycle.

For example, the third scan stages may be supplied with the first driving power source VGH and the second driving power source VGL to operate. The voltage of the first driving power source VGH may be set as a gate-high voltage, and the voltage of the second driving power source VGL may be set as a gate-low voltage.

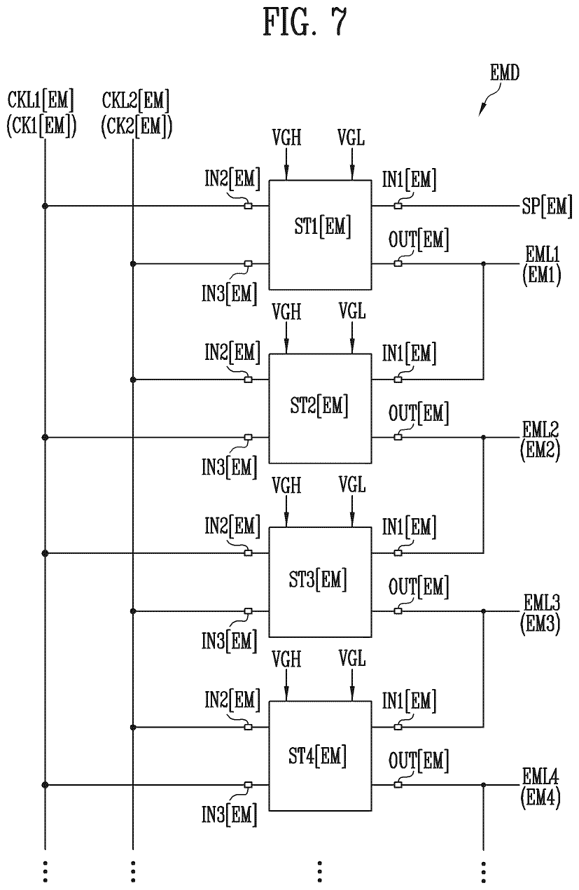

FIG. 7 is a diagram illustrating a fourth scan driver according to some embodiments of the present disclosure.

Referring to FIG. 7, the fourth scan driver EMD may include fourth scan stages for supplying the fourth scan signal EM to the fourth scan lines EML1, . . . , EMLi, . . . , and EMLm which have been described with reference to FIG. 1. The fourth scan stages may be dependently connected to each other, and sequentially output the fourth scan signal EM.

For clear and brief description, only a (4-1)th scan stage ST1[EM], a (4-2)th scan stage ST2[EM], a (4-3)th scan stage ST3[EM], and a (4-4)th scan stage ST4[EM] among the fourth scan stages are illustrated in FIG. 7. Hereinafter, the fourth scan driver EMD will be described based on the (4-1)th scan stage ST1[EM], the (4-2)th scan stage ST2[EM], the (4-3)th scan stage ST3[EM], and the (4-4)th scan stage ST4[EM].

The (4-1)th scan stage ST1[EM], the (4-2)th scan stage ST2[EM], the (4-3)th scan stage ST3[EM], and the (4-4)th scan stage ST4[EM] may be dependently connected to an input terminal of a fourth start pulse SP[EM](e.g., a first input terminal IN1[EM] of the (4-1)th scan stage ST1[EM]).

The (4-1)th scan stage ST1[EM], the (4-2)th scan stage ST2[EM], the (4-3)th scan stage ST3[EM], and the (4-4)th scan stage ST4[EM] may be connected to a (4-1)th scan line EML1, a (4-2)th scan line EML2, a (4-3)th scan line EML3, and a (4-4)th scan line EML4, respectively.

The (4-1)th scan stage ST1[EM], the (4-2)th scan stage ST2[EM], the (4-3)th scan stage ST3[EM], and the (4-4)th scan stage ST4[EM] may be connected to a (4-1)th clock signal line CKL1[EM]transferring a (4-1)th clock signal CK1[EM] and a (4-2)th clock signal line CKL2[EM]transferring a (4-2)th clock signal CK2[EM].

The (4-1)th scan stage ST1[EM], the (4-2)th scan stage ST2[EM], the (4-3)th scan stage ST3[EM], and the (4-4)th scan stage ST4[EM] may generate a (4-1)th scan signal EM1, a (4-2)th scan signal EM2, a (4-3)th scan signal EM3, and a (4-4)th scan signal EM4, respectively, using the (4-1)th clock signal CK1[EM] and the (4-2)th clock signal CK2[EM].

The (4-1)th scan stage ST1[EM], the (4-2)th scan stage ST2[EM], the (4-3)th scan stage ST3[EM], and the (4-4)th scan stage ST4[EM] may sequentially output the (4-1)th scan signal EM1, the (4-2)th scan signal EM2, the (4-3)th scan signal EM3, and the (4-4)th scan signal EM4 to the (4-1)th scan line EML1, the (4-2)th scan line EML2, the (4-3)th scan line EML3, and the (4-4)th scan line EML4. In some embodiments, the fourth scan stages may substantially have the same circuit structure.

Each of the fourth scan stages may include a first input terminal IN1[EM], a second input terminal IN2[EM], a third input terminal IN3[EM], and an output terminal OUT[EM].

The first input terminal IN1[EM] may be supplied with a first input signal. The first input signal may be the fourth start pulse SP[EM] or an output signal of a previous fourth scan stage (i.e., a fourth scan signal of the previous fourth scan stage). For example, the (4-1)th scan stage ST1[EM] may be supplied with the fourth start pulse SP[EM] through the first input terminal IN1[EM], and each of the other fourth scan stages may be supplied with an output signal of a previous fourth scan stage through a first input terminal IN1[EM] thereof.

The second input terminal IN2[EM] and the third input terminal IN3[EM] may be supplied with a second input signal and a third input signal, respectively. In some embodiments, a second input signal and a third input signal of an odd-numbered fourth scan stage may be the (4-1)th clock signal CK1[EM] and the (4-2)th clock signal CK2[EM], respectively. For example, a second input signal and a third input signal of an even-numbered fourth scan stage may be the (4-2)th clock signal CK2[EM] and the (4-1)th clock signal CK1[EM], respectively.

The (4-1)th clock signal CK1[EM] and the (4-2)th clock signal CK2[EM] may alternately have a gate-on voltage. For example, the (4-1)th clock signal CK1[EM] and the (4-2)th clock signal CK2[EM] may be signals which have the same cycle and have phases not overlapping with each other. For example, the (4-2)th clock signal CK2[EM] may be a clock signal obtained by shifting the (4-1)th clock signal CK1[EM] by a half cycle.

Additionally, the fourth scan stages may be supplied with the first driving power source VGH and the second driving power source VGL to operate. The voltage of the first driving power source VGH may be set as a gate-high voltage, and the voltage of the second driving power source VGL may be set as a gate-low voltage.

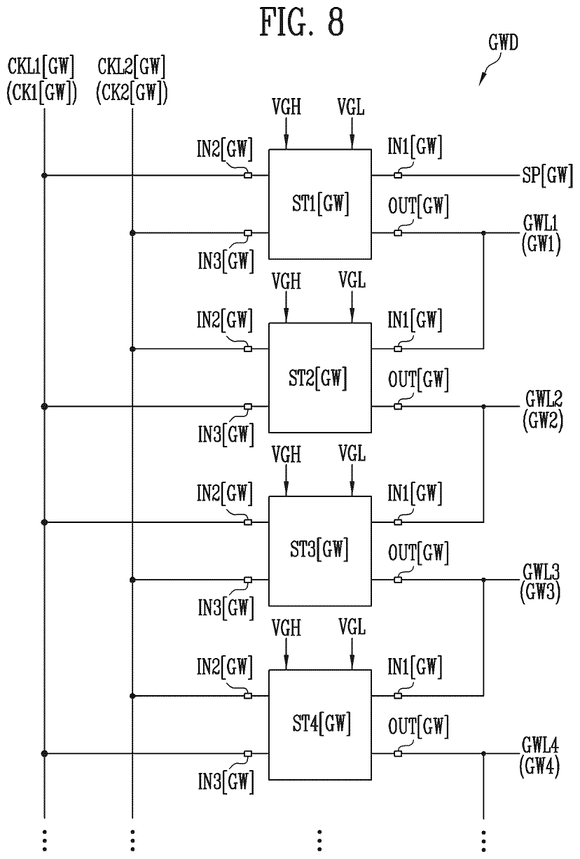

FIG. 8 is a diagram illustrating a fifth scan driver according to some embodiments of the present disclosure.

Referring to FIG. 8, the fifth scan driver GWD may include fifth scan stages for supplying the fifth scan signal GW to the fifth scan lines GWL1, . . . , GWLi, . . . , and GWLm which have been described with reference to FIG. 1. The fifth scan stages may be dependently connected to each other, and sequentially output the fifth scan signal GW.

For clear and brief description, only a (5-1)th scan stage ST1[GW], a (5-2)th scan stage ST2[GW], a (5-3)th scan stage ST3[GW], and a (5-4)th scan stage ST4[GW] among the fifth scan stages are illustrated in FIG. 8. Hereinafter, the fifth scan driver GWD will be described based on the (5-1)th scan stage ST1[GW], the (5-2)th scan stage ST2[GW], the (5-3)th scan stage ST3[GW], and the (5-4)th scan stage ST4[GW].

The (5-1)th scan stage ST1[GW], the (5-2)th scan stage ST2[GW], the (5-3)th scan stage ST3[GW], and the (5-4)th scan stage ST4[GW] may be dependently connected to an input terminal of a fifth start pulse SP[GW](e.g., a first input terminal IN1[GW] of the (5-1)th scan stage ST1[GW]).

The (5-1)th scan stage ST1[GW], the (5-2)th scan stage ST2[GW], the (5-3)th scan stage ST3[GW], and the (5-4)th scan stage ST4[GW] may be connected to a (5-1)th scan line GWL1, a (5-2)th scan line GWL2, a (5-3)th scan line GWL3, and a (5-4)th scan line GWL4, respectively.

The (5-1)th scan stage ST1[GW], the (5-2)th scan stage ST2[GW], the (5-3)th scan stage ST3[GW], and the (5-4)th scan stage ST4[GW] may be connected to a (5-1)th clock signal line CKL1[GW]transferring a (5-1)th clock signal CK1[GW] and a (5-2)th clock signal line CKL2[GW]transferring a (5-2)th clock signal CK2[GW].

The (5-1)th scan stage ST1[GW], the (5-2)th scan stage ST2[GW], the (5-3)th scan stage ST3[GW], and the (5-4)th scan stage ST4[GW] may generate a (5-1)th scan signal GW1, a (5-2)th scan signal GW2, a (5-3)th scan signal GW3, and a (5-4)th scan signal GW4, respectively, using the (5-1)th clock signal CK1[GW] and the (5-2)th clock signal CK2[GW].

The (5-1)th scan stage ST1[GW], the (5-2)th scan stage ST2[GW], the (5-3)th scan stage ST3[GW], and the (5-4)th scan stage ST4[GW] may sequentially output the (5-1)th scan signal GW1, the (5-2)th scan signal GW2, the (5-3)th scan signal GW3, and the (5-4)th scan signal GW4 to the (5-1)th scan line GWL1, the (5-2)th scan line GWL2, the (5-3)th scan line GWL3, and the (5-4)th scan line GWL4. In some embodiments, the fifth scan stages may substantially have the same circuit structure.

Each of the fifth scan stages may include a first input terminal IN1[GW], a second input terminal IN2[GW], a third input terminal IN3[GW], and an output terminal OUT[GW].

The first input terminal IN1[GW] may be supplied with a first input signal. The first input signal may be the fifth start pulse SP[GW] or an output signal of a previous fifth scan stage (i.e., a fifth scan signal of the previous fifth scan stage). For example, the (5-1)th scan stage ST1[GW] may be supplied with the fifth start pulse SP[GW] through the first input terminal IN1[GW], and each of the other fifth scan stages may be supplied with an output signal of a previous fifth scan stage through a first input terminal IN1[GW] thereof.

The second input terminal IN2[GW] and the third input terminal IN3[GW] may be supplied with a second input signal and a third input signal, respectively. In some embodiments, a second input signal and a third input signal of an odd-numbered fifth scan stage may be the (5-1)th clock signal CK1[GW] and the (5-2)th clock signal CK2[GW], respectively. For example, a second input signal and a third input signal of an even-numbered fifth scan stage may be the (5-2)th clock signal CK2[GW] and the (5-1)th clock signal CK1[GW], respectively.

The (5-1)th clock signal CK1[GW] and the (5-2)th clock signal CK2[GW] may alternately have a gate-on voltage. For example, the (5-1)th clock signal CK1[GW] and the (5-2)th clock signal CK2[GW] may be signals which have the same cycle and have phases not overlapping with each other. For example, the (5-2)th clock signal CK2[GW] may be a clock signal obtained by shifting the (5-1)th clock signal CK1[GW] by a half cycle.

Additionally, the fifth scan stages may be supplied with the first driving power source VGH and the second driving power source VGL to operate. The voltage of the first driving power source VGH may be set as a gate-high voltage, and the voltage of the second driving power source VGL may be set as a gate-low voltage.

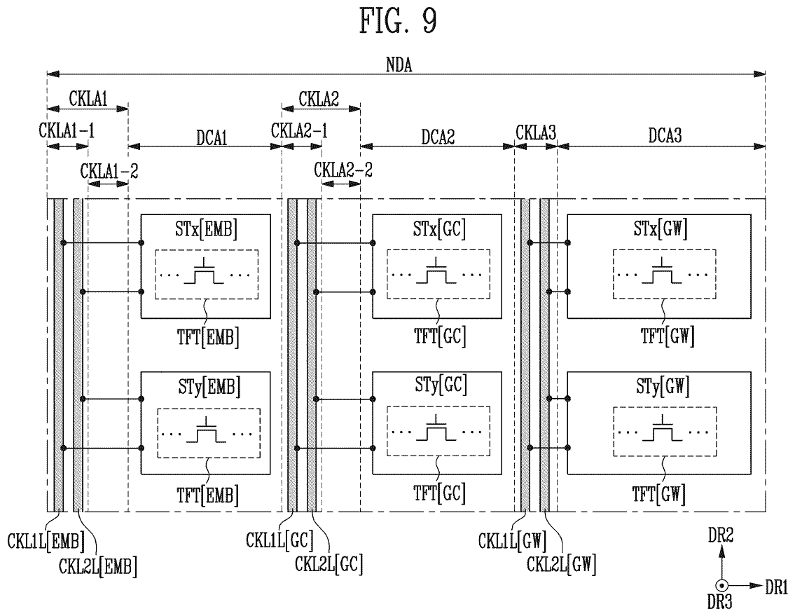

FIGS. 9 to 14 are diagrams illustrating a scan driver according to some embodiments of the present disclosure.

Referring to FIG. 9, components implemented with the first circuit element layer LL1 among components constituting the scan driver are illustrated.

In some embodiments, a non-display area NDA may be defined. The non-display area may be an area except an area (i.e., the display area DA) corresponding to the pixel unit 14 which has been described with reference to FIG. 1.

The non-display area NDA may include a first line area CKLA1, a first circuit element area DCA1, a second line area CKLA2, a second circuit element area DCA2, a third line area CKLA3, and a third circuit element area DCA3, which are sequentially disposed along the first direction DR1. The first line area CKLA1 may include a (1-1)th line area CKLA1-1 and a (1-2)th line area CKLA1-2 adjacent to the (1-1)th line area CKLA1-1 in the first direction DR1. The second line area CKLA2 may include a (2-1)th line area CKLA2-1 and a (2-2)th line area CKLA2-2 adjacent to the (2-1)th line area CKLA2-1 in the first direction DR1.

A (1-1)th lower clock signal line CKL1L[EMB] and a (1-2)th lower clock signal line CKL2L[EMB] may be disposed in the (1-1)th line area CKLA1-1. The (1-1)th lower clock signal line CKL1L[EMB] and the (1-2)th lower clock signal line CKL2L[EMB] may extend in the second direction DR2, and be spaced apart from each other in the first direction DR1.

First scan stages STx[EMB] and STy[EMB] may be disposed in the first circuit element area DCA1. The first scan stages STx[EMB] and STy[EMB] may be understood as a first scan stage of an x-th row and a first scan stage of a y-th row. Here, x may be an integer of 1 or more and m−1 or less, and y may be x+1. The first scan stages STx[EMB] and STy[EMB] may be electrically connected to the (1-1)th lower clock signal line CKL1L[EMB] and the (1-2)th lower clock signal line CKL2L[EMB].

The first scan stages STx[EMB] and STy[EMB] may include a first circuit element TFT[EMB]. The first circuit element TFT[EMB] may be implemented with the first circuit element layer LL1 which has been described with reference to FIG. 3. The first circuit element TFT[EMB] may include transistors and capacitors.

A (3-1)th lower clock signal line CKL1L[GC] and a (3-2)th lower clock signal line CKL2L[GC] may be disposed in the (2-1)th line area CKLA2-1. The (3-1)th lower clock signal line CKL1L[GC] and the (3-2)th lower clock signal line CKL2L[GC] may extend in the second direction DR2, and be spaced apart from each other in the first direction DR1.

Third scan stages STx[GC] and STy[GC] may be disposed in the second circuit element area DCA2. The third scan stages STx[GC] and STy[GC] may be understood as a third scan stage of the xth row and a third scan stage of the yth row. The third scan stages STx[GC] and STy[GC] may be electrically connected to the (3-1)th lower clock signal line CKL1L[GC] and the (3-2)th lower clock signal line CKL2L[GC].

The third scan stages STx[GC] and STy[GC] may include a third circuit element TFT[CG]. The third circuit element TFT[GC] may include transistors and capacitors.

A (5-1)th lower clock signal line CKL1L[GW] and a (5-2)th lower clock signal line CKL2L[GW] may be disposed in the third line area CKLA3. The (5-1)th lower clock signal line CKL1L[GW] and the (5-2)th lower clock signal line CKL2L[GW] may extend in the second direction DR2, and be spaced apart from each other in the first direction DR1.

Fifth scan stages STx[GW] and STy[GW] may be disposed in the third circuit element area DCA3. The fifth scan stages STx[GW] and STy[GW] may be understood as a fifth scan stage of the xth row and a fifth scan stage of the yth row. The fifth scan stages STx[GW] and STy[GW] may be electrically connected to the (5-1)th lower clock signal line CKL1L[GW] and the (5-2)th lower clock signal line CKL2L[GW].

The fifth scan stages STx[GW] and STy[GW] may include a fifth circuit element TFT[GW]. The fifth circuit element TFT[GW] may be implemented with the first circuit element LL1 which has been described with reference to FIG. 3. The fifth circuit element TFT[GW] may include transistors and capacitors.

In some embodiments, as shown in FIG. 9, a width of each of the fifth scan stages STx[GW] and STy[GW] in the first direction DR1 on a plane may be relatively large. For example, the width of each of the fifth scan stages STx[GW] and STy[GW] in the first direction DR1 may be larger than a width of each of the third scan stages STx[GC] and STy[GC] in the first direction DR1. For example, the width of each of the fifth scan stages STx[GW] and STy[GW] in the first direction DR1 may be larger than a width of each of the first scan stages STx[EMB] and STy[EMB] in the first direction DR1.

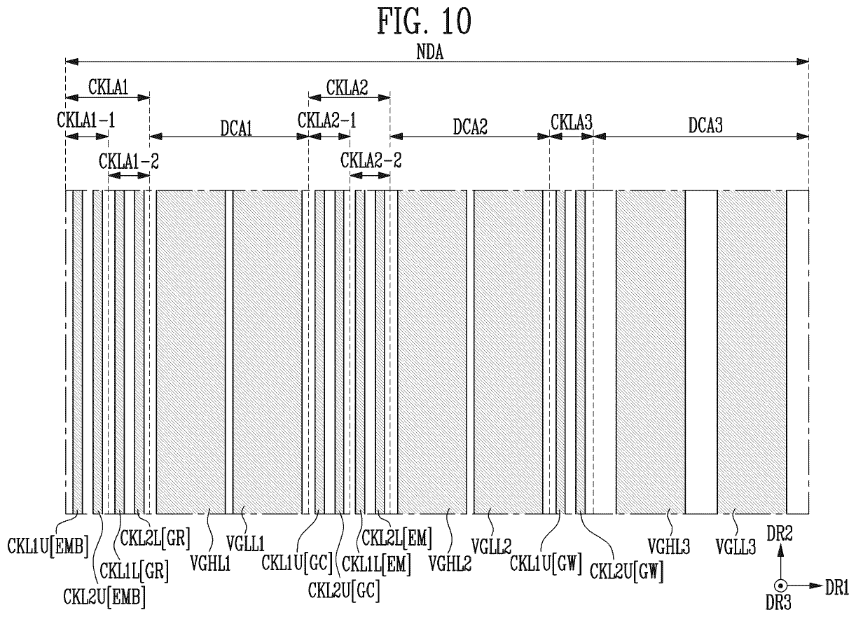

Referring to FIG. 10, components implemented with the intermediate circuit element layer LLM among the components constituting the scan driver are illustrated. An area shown in FIG. 10 may be identical to the area shown in FIG. 9.

A (1-1)th upper clock signal line CKL1U[EMB] and a (1-2)th upper clock signal line CKL2U[EMB] may be disposed in the (1-1)th line area CKLA1-1. The (1-1)th upper clock signal line CKL1U[EMB] and the (1-2)th upper clock signal line CKL2U[EMB] may extend in the second direction DR2, and be spaced apart from each other in the first direction DR1. In some embodiments, the (1-1)th upper clock signal line CKL1U[EMB] may overlap with the (1-1)th lower clock signal line CKL1L[EMB](see, e.g., FIG. 9), and the (1-2)th upper clock signal line CKL2U[EMB] may overlap with the (1-2)th lower clock signal line CKL1L[EMB](see, e.g., FIG. 9).

A (2-1)th lower clock signal line CKL1L[GR] and a (2-2)th lower clock signal line CKL2L[GR] may be disposed in the (1-2)th line area CKLA1-2. The (2-1)th lower clock signal line CKL1L[GR] and the (2-2)th lower clock signal line CKL2L[GR] may extend in the second direction DR2, and be spaced apart from each other in the first direction DR1.

A (1-1)th driving power line VGHL1 and a (1-2)th driving power line VGLL1 may be disposed in the first circuit element area DCA1. The (1-1)th driving power line VGHL1 and the (1-2)th driving power line VGLL1 may extend in the second direction DR2, and be spaced apart from each other in the first direction DR1. The first driving power source VGH may be applied to the (1-1)th driving power line VGHL1, and the second driving power source VGL may be applied to the (1-2)th driving power line VGLL1.

A (3-1)th upper clock signal line CKL1U[GC] and a (3-2)th upper clock signal line CKL2U[GC] may be disposed in the (2-1)th line area CKLA2-1. The (3-1)th upper clock signal line CKL1U[GC] and the (3-2)th upper clock signal line CKL2U[GC] may extend in the second direction DR2, and be spaced apart from each other in the first direction DR1. In some embodiments, the (3-1)th upper clock signal line CKL1U[GC] may overlap with the (3-1)th lower clock signal line CKL1L[GC](see, e.g., FIG. 9), and the (3-2)th upper clock signal line CKL2U[GC] may overlap with the (3-2)th lower clock signal line CKL2L[GC](see, e.g., FIG. 9).

A (4-1)th lower clock signal line CKL1L[EM] and a (4-2)th lower clock signal line CKL2L[EM] may be disposed in the (2-2)th line area CKLA2-2. The (4-1)th lower clock signal line CKL1L[EM] and the (4-2)th lower clock signal line CKL2L[EM] may extend in the second direction DR2, and be spaced apart from each other in the first direction DR1.

A (2-1)th driving power line VGHL2 and a (2-2)th driving power line VGLL2 may be disposed in the second circuit element area DCA2. The (2-1)th driving power line VGHL2 and the (2-2)th driving power line VGLL2 may extend in the second direction DR2, and be spaced apart from each other in the first direction DR1. The first driving power source VGH may be applied to the (2-1)th driving power line VGHL2, and the second driving power source VGL may be applied to the (2-2)th driving power line VGLL2.

A (5-1)th upper clock signal line CKL1U[GW] and a (5-2)th upper clock signal line CKL2U[GW] may be disposed in the third line area CKLA3. The (5-1)th upper clock signal line CKL1U[GW] and the (5-2)th upper clock signal line CKL2U[GW] may extend in the second direction DR2, and be spaced apart from each other in the first direction DR1. In some embodiments, the (5-1)th upper clock signal line CKL1U[GW] may overlap with the (5-1)th lower clock signal line CKL1L[GW](see, e.g., FIG. 9), and the (5-2)th upper clock signal line CKL2U[GW] may overlap with the (5-2)th lower clock signal line CKL2L[GW](see, e.g., FIG. 9).

A (3-1)th driving power line VGHL3 and a (3-2)th driving power line VGLL3 may be disposed in the third circuit element area DCA3. The (3-1)th driving power line VGHL3 and the (3-2)th driving power line VGLL3 may extend in the second direction DR2, and be spaced apart from each other in the first direction DR1.

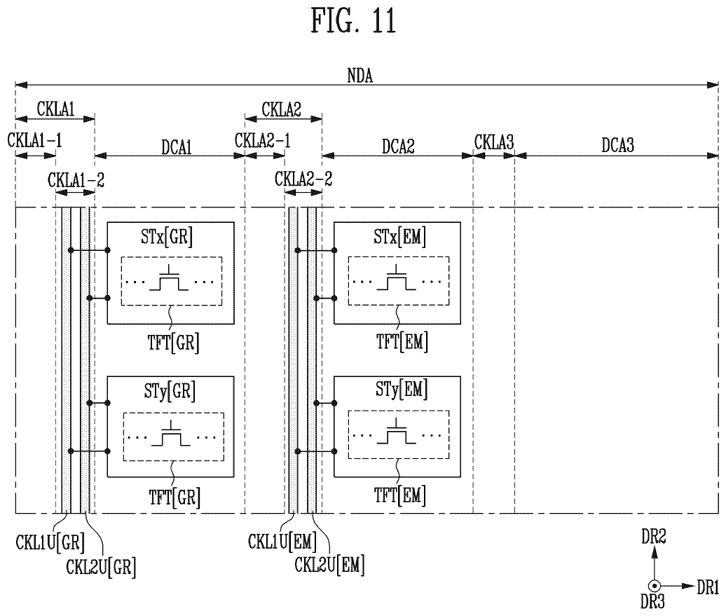

Referring to FIG. 11, components implemented with the second circuit element layer LL2 among the components constituting the scan driver are illustrated. An area shown in FIG. 11 may be identical to the areas shown in FIGS. 9 and 10.

A (2-1)th upper clock signal line CKL1U[GR] and a (2-2)th upper clock signal line CKL2U[GR] may be disposed in the (1-2)th line area CKLA1-2. The (2-1)th upper clock signal line CKL1U[GR] and the (2-2)th upper clock signal line CKL2U[GR] may extend in the second direction DR2, and be spaced apart from each other in the first direction DR1. In some embodiments, the (2-1)th upper clock signal line CKL1U[GR] may overlap with the (2-1)th lower clock signal line CKL1L[GR](see, e.g., FIG. 10), and the (2-2)th upper clock signal line CKL2U[GR] may overlap with the (2-2)th lower clock signal line CKL2L[GR](see, e.g., FIG. 10).

Second scan stages STx[GR] and STy[GR] may be disposed in the first circuit element area DCA1. The second scan stages STx[GR] and STy[GR] may be understood as a second scan stage of the x-th row and a second scan stage of the y-th row. The second scan stages STx[GR] and STy[GR] may be electrically connected to the (2-1)th upper clock signal line CKL1U[GR] and the (2-2)th upper clock signal line CKL2U[GR].

The second scan stages STx[GR] and STy[GR] may include a second circuit element TFT[GR]. The second circuit element TFT[GR] may be implemented with the second circuit element layer LL2 which has been described with reference to FIG. 3. The second circuit element TFT[GR] may include transistors and capacitors. The second circuit element TFT[GR] may overlap with the first circuit element TFT[EMB] which has been described with reference to FIG. 9.

A (4-1)th upper clock signal line CKL1U[EM] and a (4-2)th upper clock signal line CKL2U[EM] may be disposed in the (2-2)th line area CKLA2-2. The (4-1)th upper clock signal line CKL1U[EM] and the (4-2)th upper clock signal line CKL2U[EM] may extend in the second direction DR2, and be spaced apart from each other in the first direction DR1. In some embodiments, the (4-1)th upper clock signal line CKL1U[EM] may overlap with the (4-1)th lower clock signal line CKL1L[EM](see, e.g., FIG. 10), and the (4-2)th upper clock signal line CKL2U[EM] may overlap with the (4-2)th lower clock signal line CKL2L[EM](see, e.g., FIG. 10).

Fourth scan stages STx[EM] and STy[EM] may be disposed in the second circuit element area DCA2. The fourth scan stages STx[EM] and STy[EM] may be understood as a fourth scan stage of the x-th row and a fourth scan stage of the y-th row. The fourth scan stages STx[EM] and STy[EM] may be electrically connected to the (4-1)th upper clock signal line CKL1U[EM] and the (4-2)th upper clock signal line CKL2U[EM].

The fourth scan stages STx[EM] and STy[EM] may include a fourth circuit element TFE[EM]. The fourth circuit element TFE[EM] may be implemented with the second circuit element layer LL2 which has been described with reference to FIG. 3. The fourth circuit element TFT[EM] may include transistors and capacitors. The fourth circuit element TFT[EM] may overlap with the third circuit element TFT[GC] which has been described with reference to FIG. 9.

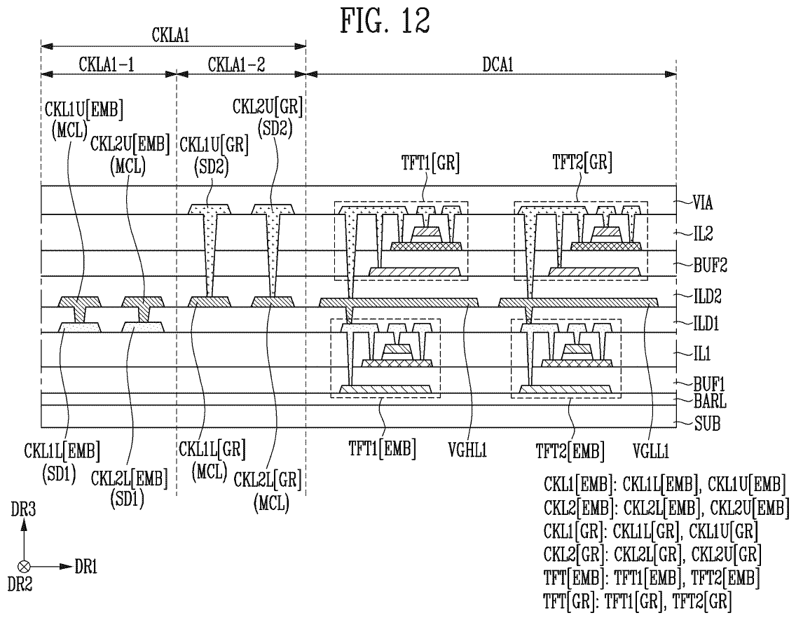

Referring to FIG. 12, a sectional shape of the first line area and a first circuit element area adjacent thereto is illustrated.

In some embodiments, the (1-1) the upper clock signal line CKL1U[EMB] may be electrically connected to the (1-1)th lower clock signal line CKL1L[EMB] through a penetration hole penetrating the first interlayer insulating layer ILD1. The (1-1)th lower clock signal line CKL1L[EMB] and the (1-1)th upper clock signal line CKL1U[EMB] may form the (1-1)th clock signal line CKL1[EMB]. As such, as the (1-1)th clock signal line CKL1[EMB] may have a double-layer structure configured with the (1-1)th lower clock signal line CKL1L[EMB] and the (1-1)th upper clock signal line CKL1U[EMB], the resistance of the (1-1)th clock signal line CKL1[EMB] can be relatively decreased.

In some embodiments, the (1-2)th upper clock signal line CKL2U[EMB] may be electrically connected to the (1-2)th lower clock signal line CKL2L[EMB] through a penetration hole penetrating the first interlayer insulating layer ILD1. The (1-2)th lower clock signal line CKL2L[EMB] and the (1-2)th upper clock signal line CKL2U[EMB] may form the (1-2)th clock signal line CKL2[EMB]. As such, as the (1-2)th clock signal line CKL2[EMB] may have a double-layer structure configured with the (1-2)th lower clock signal line CKL2L[EMB] and the (1-2)th upper clock signal line CKL2U[EMB], the resistance of the (1-2)th clock signal line CKL2[EMB] can be relatively decreased.

In some embodiments, the (2-1)th upper clock signal line CKL1U[GR] may be electrically connected to the (2-1)th lower clock signal line CKL1L[GR] through a penetration hole penetrating the second insulating layer IL2, the second buffer layer BUF2, and the second interlayer insulating layer ILD2. The (2-1)th lower clock signal line CKL1L[GR] and the (2-1)th upper clock signal line CKL1U[GR] may form the (2-1)th clock signal line CKL1[GR]. As such, as the (2-1)th clock signal line CKL1[GR] may have a double-layer structure configured with the (2-1)th lower clock signal line CKL1L[GR] and the (2-1)th upper clock signal line CKL1U[GR], the resistance of the (2-1)th clock signal line CKL1[GR] can be relatively decreased.

In some embodiments, the (2-2)th upper clock signal line CKL2U[GR] may be electrically connected to the (2-2)th lower clock signal line CKL2L[GR] through a penetration hole penetrating the second insulating layer IL2, the second buffer layer BUF2, and the second interlayer insulating layer ILD2. The (2-2)th lower clock signal line CKL2L[GR] and the (2-2)th upper clock signal line CKL2U[GR] may form the (2-2)th clock signal line CKL2[GR]. As such, as the (2-2)th clock signal line CKL2[GR] may have a double-layer structure configured with the (2-2)th lower clock signal line CKL2L[GR] and the (2-2)th upper clock signal line CKL2U[GR], the resistance of the (2-2)th clock signal line CKL2[GR] can be relatively decreased.

The first circuit element TFT[EMB] may include a (1-1)th circuit element TFT1[EMB] and a (1-2)th circuit element TFT2[EMB]. The second circuit element TFT[GR] may include a (2-1)th circuit element TFT1[GR] and a (2-2)th circuit element TFT2[GR].

In some embodiments, the (1-1)th circuit element TFT1[EMB] may overlap with the (2-1)th circuit element TFT1[GR], and the (1-2)th circuit element TFT2[EMB] may overlap with the (2-2)th circuit element TFT2[GR]. As such, the first circuit element TFT[EMB] and the second circuit element TFT[GR] may be disposed while overlapping with each other, so that the width of the first circuit element area DCA1 in the first direction DR1 can be relatively decreased. Accordingly, the area of the non-display area NDA can be reduced, and a narrow-bezel display device can be implemented.

In some embodiments, the (1-1)th driving power line VGHL1 may be disposed between the (1-1)th circuit element TFT1[EMB] and the (2-1)th circuit element TFT1[GR], and the (1-2)th driving power line VGLL1 may be disposed between the (1-2)th circuit element TFT2[EMB] and the (2-2)th circuit element TFT2[GR]. The (1-1)th driving power line VGHL1 and the (1-2)th driving power line VGLL1 may function to prevent or substantially reduce signal interference between the first circuit element TFT[EMB] and the second circuit element TFT[GR]. Accordingly, the reliability of the first scan driver EMBD including the first circuit element TFT[EMB] and the second scan driver GRD including the second circuit element TFT[GR] can be improved (e.g., increased or substantially increased).

In some embodiments, the (1-1)th driving power line VGHL1 may be electrically connected to the (1-1)th circuit element TFT1[EMB] and the (2-1)th circuit element TFT1[GR], and the (1-2)th driving power line VGLL1 may be electrically connected to the (1-2)th circuit element TFT2[EMB] and the (2-2)th circuit element TFT2[GR]. Accordingly, the (1-1)th driving power line VGHL1 can transfer the first driving power source VGH to the first scan driver EMBD and the second scan driver GRD, and the (1-2)th driving power line VGLL1 can transfer the second driving power source VGL to the first scan driver EMBD and the second scan driver GRD.

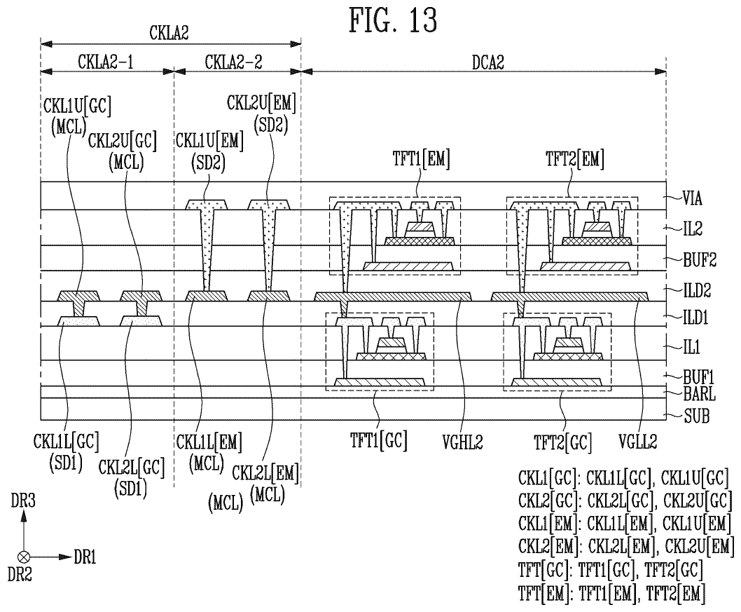

Referring to FIG. 13, a sectional shape of the second line area and the second circuit element area adjacent thereto is illustrated.

In some embodiments, the (3-1)th upper clock signal line CKL1U[GC] may be electrically connected to the (3-1)th lower clock signal line CKL1L[GC] through a penetration hole penetrating the first interlayer insulating layer ILD1. The (3-1)th lower clock signal line CKL1L[GC] and the (3-1)th upper clock signal line CKL1U[GC] may form the (3-1)th clock signal line CKL1[GC]. As such, as the (3-1)th clock signal line CKL1[GC] may have a double-layer structure configured with the (3-1)th lower clock signal line CKL1L[GC] and the (3-1)th upper clock signal line CKL1U[GC], the resistance of the (3-1)th clock signal line CKL1[GC] can be relatively decreased.

In some embodiments, the (3-2)th upper clock signal line CKL2U[GC] may be electrically connected to the (3-2)th lower clock signal line CKL2L[GC] through a penetration hole penetrating the first interlayer insulating layer ILD1. The (3-2)th lower clock signal line CKL2L[GC] and the (3-2)th upper clock signal line CKL2U[GC] may form the (3-2)th clock signal line CKL2[GC]. As such, as the (3-2)th clock signal line CKL2[GC] may have a double-layer structure configured with the (3-2)th lower clock signal line CKL2L[GC] and the (3-2)th upper clock signal line CKL2U[GC], the resistance of the (3-2)th clock signal line CKL2[GC] can be relatively decreased.

In some embodiments, the (4-1)th upper clock signal line CKL1U[EM] may be electrically connected to the (4-1)th lower clock signal line CKL1L[EM] through a penetration hole penetrating the second insulating layer IL2, the second buffer layer BUF2, and the second interlayer insulating layer ILD2. The (4-1)th lower clock signal line CKL1L[EM] and the (4-1)th upper clock signal line CKL1U[EM] may form the (4-1)th clock signal line CKL1[EM]. As such, as the (4-1)th clock signal line CKL1[EM] may have a double-layer structure configured with the (4-1)th lower clock signal line CKL1L[EM] and the (4-1)th upper clock signal line CKL1U[EM], the resistance of the (4-1)th clock signal line CKL1[EM] can be relatively decreased.

In some embodiments, the (4-2)th upper clock signal line CKL2U[EM] may be electrically connected to the (4-2)th lower clock signal line CKL2L[EM] through a penetration hole penetrating the second insulating layer IL2, the second buffer layer BUF2, and the second interlayer insulating layer ILD2. The (4-2)th lower clock signal line CKL2L[EM] and the (4-2)th upper clock signal line CKL2U[EM] may form the (4-2)th clock signal line CKL2[EM]. As such, as the (4-2)th clock signal line CKL2[EM] may have a double-layer structure configured with the (4-2)th lower clock signal line CKL2L[EM] and the (4-2)th upper clock signal line CKL2U[EM], the resistance of the (4-2)th clock signal line CKL2[EM] can be relatively decreased.

The third circuit element TFT[GC] may include a (3-1)th circuit element TFT1[GC] and a (3-2)th circuit element TFT2[GC], and the fourth circuit element TFT[EM] may include a (4-1)th circuit element TFT1[EM] and a (4-2)th circuit element TFT2[EM].

In some embodiments, the (3-1)th circuit element TFT1[GC] may overlap with the (4-1)th circuit element TFT1[EM], and the (3-2)th circuit element TFT2[GC] may overlap with the (4-2)th circuit element TFT2[EM]. As such, the third circuit element TFT[CG] and the fourth circuit element TFT[EM] may be disposed while overlapping with each other, so that the width of the second circuit element area DCA2 in the first direction DR1 can be relatively decreased. Accordingly, the area of the non-display area NDA can be reduced, and a narrow-bezel display device can be implemented.

In some embodiments, the (2-1)th driving power line VGHL2 may be disposed between the (3-1)th circuit element TFT1[GC] and the (4-1)th circuit element TFT1[EM], and the (2-2)th driving power line VGLL2 may be disposed between the (3-2)th circuit element TFT2[GC] and the (4-2)th circuit element TFT2[EM]. The (2-1)th driving power line VGHL2 and the (2-2)th driving power line VGLL2 may function to prevent or substantially reduce signal interference between the third circuit element TFT[GC] and the fourth circuit element TFT[EM]. Accordingly, the reliability of the third scan driver GCD including the third circuit element TFT[GC] and the fourth scan driver EMD including the fourth circuit element TFT[EM] can be improved (e.g., increased or substantially increased).

In some embodiments, the (2-1)th driving power line VGHL2 may be electrically connected to the (3-1)th circuit element TFT1[GC] and the (4-1)th circuit element TFT1[EM], and the (2-2)th driving power line VGLL2 may be electrically connected to the (3-2)th circuit element TFT2[GC] and the (4-2)th circuit element TFT2[EM]. Accordingly, the (2-1)th driving power line VGHL2 can transfer the first driving power source VGH to the third scan driver GCD and the fourth scan driver EMD, and the (2-2)th driving power line VGLL2 can transfer the second driving power source VGL to the third scan driver GCD and the fourth scan driver EMD.

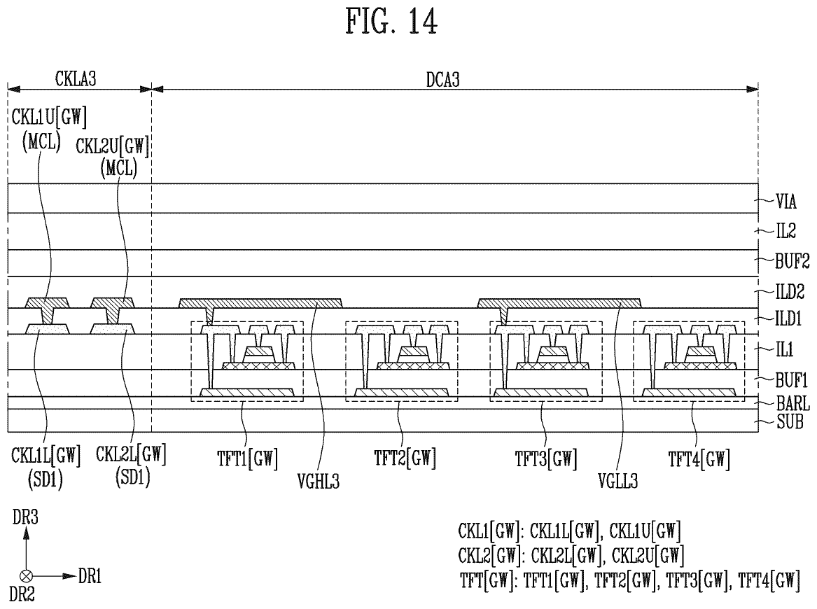

Referring to FIG. 14, a sectional shape of the third line area and a third circuit element area adjacent to each other is illustrated.

In some embodiments, the (5-1)th upper clock signal line CKL1U[GW] may be electrically connected to the (5-1)th lower clock signal line CKL1L[GW] through a penetration hole penetrating the first interlayer insulating layer ILD1. The (5-1)th lower clock signal line CKL1L[GW] and the (5-1)th upper clock signal line CKL1U[GW] may form the (5-1)th clock signal line CKL1[GW]. As such, as the (5-1)th clock signal line CKL1[GW] may have a double-layer structure configured with the (5-1)th lower clock signal line CKL1L[GW] and the (5-1)th upper clock signal line CKL1U[GW], the resistance of the (5-1)th clock signal line CKL1[GW] can be relatively decreased.

In some embodiments, the (5-2)th upper clock signal line CKL2U[GW] may be electrically connected to the (5-2)th lower clock signal line CKL2L[GW] through a penetration hole penetrating the first interlayer insulating layer ILD1. The (5-2)th lower clock signal line CKL2L[GW] and the (5-2)th upper clock signal line CKL2U[GW] may form the (5-2)th clock signal line CKL2[GW]. As such, as the (5-2)th clock signal line CKL2[GW] may have a double-layer structure configured with the (5-2)th lower clock signal line CKL2L[GW] and the (5-2)th upper clock signal line CKL2U[GW], the resistance of the (5-2)th clock signal line CKL2[GW] can be relatively decreased.

The fifth circuit element TFT[GW] may include a (5-1)th circuit element TFT1[GW], a (5-2)th circuit element TFT2[GW], a (5-3)th circuit element TFT3[GW], and a (5-4)th circuit element TFT4[GW].

In some embodiments, the (3-1)th driving power line VGHL3 may be electrically connected to the (5-1)th circuit element TFT1[GW], and the (3-2)th driving power line VGLL3 may be electrically connected to the (5-3)th circuit element TFT3[GW]. Accordingly, the (3-1)th driving power line VGHL3 can transfer the first driving power source VGH to the fifth scan driver GWD, and the (3-2)th driving power line VGLL3 can transfer the second driving power source VGL to the fifth scan driver GWD.

Referring back to FIGS. 9 to 14, in the present disclosure, circuit elements constituting different kinds of scan drivers may be disposed while overlapping with each other, so that the area of the non-display area NDA can be reduced. Accordingly, a narrow-bezel display device can be implemented.

Clock signal lines to which different kinds of clock signals are applied may be disposed not to overlap with each other. Accordingly, signal interference between the clock signal lines can be prevented or substantially reduced.

In addition, the clock line signals may be disposed not to overlap with a driving power line to which the first driving power source VGH and the second power source VGL are applied. Accordingly, signal interference between the clock signal lines and the driving power line can be prevented or substantially reduced.

That is, in some embodiments of the present disclosure, the display device capable of preventing or substantially reducing signal interference between signal lines while implementing a narrow-bezel display device can be provided.

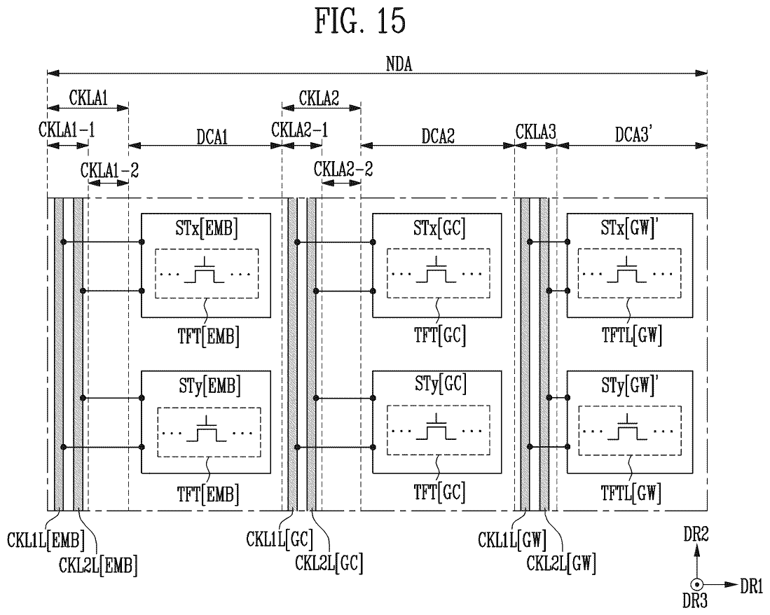

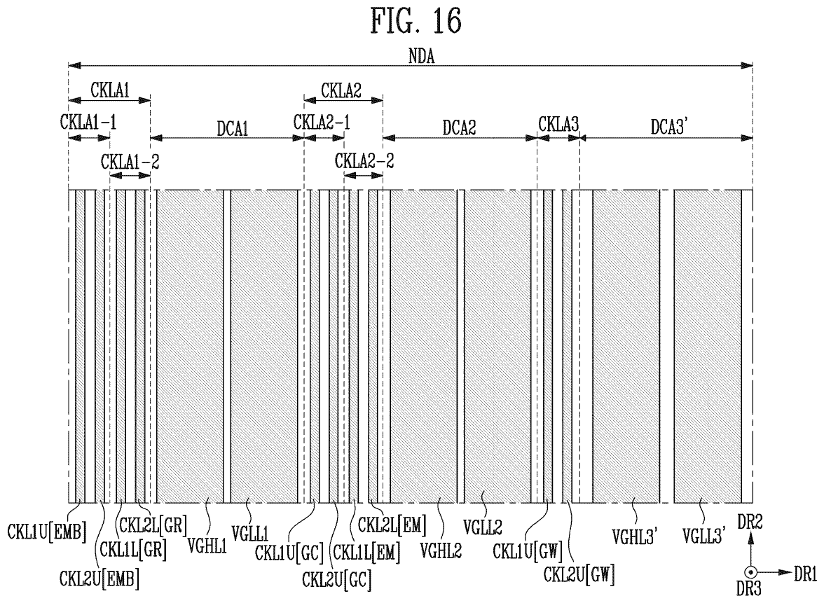

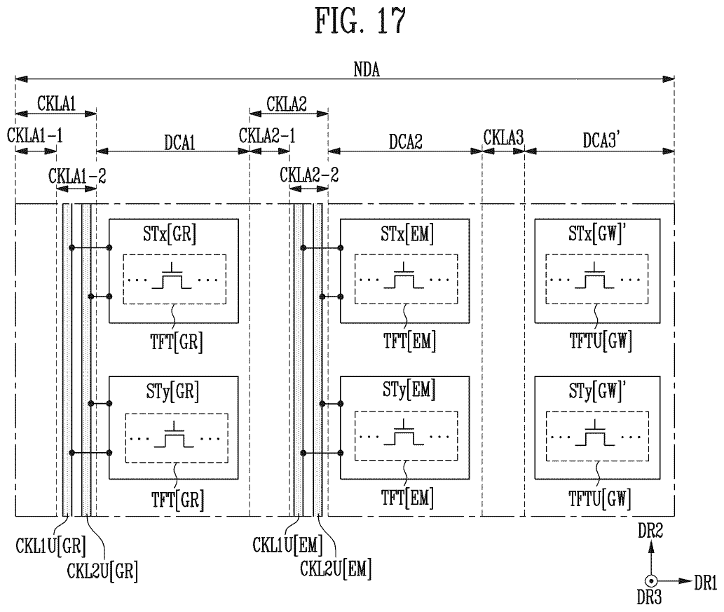

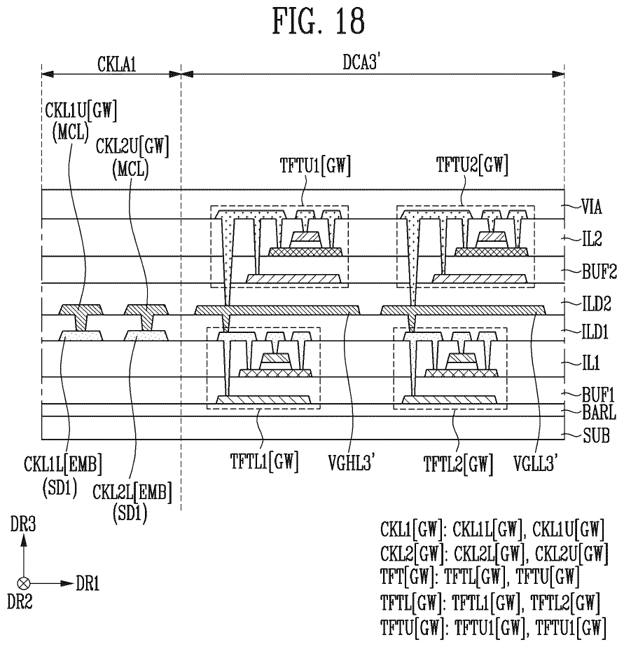

FIGS. 15 to 18 are diagrams illustrating a scan driver according to some embodiments of the present disclosure.

Hereinafter, in FIGS. 15 to 18, portions different from the portions which have been described with reference to FIGS. 9 to 14 will be mainly described, and portions of which description is omitted may be the same as the above-described portions.

Referring to FIGS. 15 to 18, fifth stages STx[GW]′ and STy[GW]′, a (3-1)th driving power line VGHL3′, and a (3-2)th driving power line VGLL3′ may be disposed in a third circuit element area DCA3′.

The fifth stages STx[GW]′ and STy[GW]′ may include a fifth lower circuit element TFTL[GW] implemented with the first circuit element layer LL1 which has been described with reference to FIG. 3 and a fifth upper circuit element TFTU[GW] implemented with the second circuit element layer LL2 which has been described with reference to FIG. 3. The fifth lower circuit element TFTL[GW] may be disposed to overlap with the fifth upper circuit element TFTU[GW]. Accordingly, a width of the third circuit element area DCA3′ in the first direction DR1 may be smaller than the width of the third circuit element area DCA3 which has been described with reference to FIGS. 9 to 14 in the first direction DR1. Thus, a narrow bezel can be more easily implemented.

The fifth lower circuit element TFTL[GW] may include a (5-1)th lower circuit element TFTL1[GW] and a (5-2)th lower circuit element TFTL2[GW]. The fifth upper circuit element TFTU[GW] may include a (5-1)th upper circuit element TFTU1[GW] and a (5-2)th upper circuit element TFTU2[GW].

In some embodiments, the (3-1)th driving power line VGHL3′ may be disposed between the (5-1)th lower circuit element TFTL1[GW] and the (5-1)th upper circuit element TFTU1[GW]. The (3-1)th driving power line VGHL3′ may function to prevent or substantially reduce signal interference between the (5-1)th lower circuit element TFTL1[GW] and the (5-1)th upper circuit element TFTU1[GW].

In some embodiments, the (3-1)th driving power line VGHL3′ may be electrically connected to the (5-1)th lower circuit element TFTL1[GW] and the (5-1)th upper circuit element TFTU1[GW]. The (5-1)th lower circuit element TFTL1[GW] and the (5-1)th upper circuit element TFTU1[GW] may be electrically connected to each other through the (3-1)th driving power line VGHL3′.

In some embodiments, the (3-2)th driving power line VGLL3′ may be disposed between the (5-2)th lower circuit element TFTL2[GW] and the (5-2)th upper circuit element TFTU2[GW]. The (3-2)th driving power line VGLL3′ may function to prevent or substantially reduce signal interference between the (5-2)th lower circuit element TFTL2[GW] and the (5-2)th upper circuit element TFTU2[GW].

In some embodiments, the (3-2)th driving power line VGLL3′ may be electrically connected to the (5-2)th lower circuit element TFTL2[GW] and the (5-2)th upper circuit element TFTU2[GW]. The (5-2)th lower circuit element TFTL2[GW] and the (5-2)th upper circuit element TFTU2[GW] may be electrically connected to each other through the (3-2)th driving power line VGLL3′.

As such, in accordance with the modified example of the present disclosure, circuit elements may be disposed in one stage while overlapping with each other, so that the display device capable of more easily implementing a narrow bezel can be provided.

In accordance with the present disclosure, circuit elements constituting different kinds of scan drivers may be disposed while overlapping with each other, so that the area of the non-display area can be reduced. Thus, the display device having a narrow bezel can be implemented.

A display device according to some embodiments is applicable to various types of electronic devices. In some embodiments, an electronic device includes the above-described display device and may further include other modules or devices having additional functions in addition to the display device.

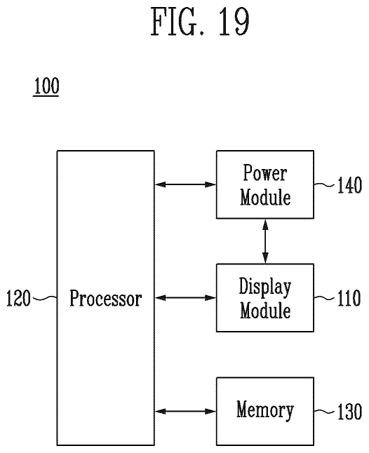

FIG. 19 is a block diagram of an electronic device according to some embodiments of the present disclosure. Referring to FIG. 19, the electronic device 100 may include a display module 110, a processor 120, a memory 130, and a power module 140.

The processor 120 may include at least one of a central processing unit (CPU), an application processor (AP), a graphic processing unit (GPU), a communication processor (CP), an image signal processor (ISP), and a controller.

The memory 130 may store data and/or information used to operate the processor 120 or the display module 110. When the processor 120 executes an application stored in the memory 130, image data signals and/or input control signals may be transferred to the display module 110. The display module 110 may process the provided signals and output image information on a display screen.

The power module 140 may include a power supply module, such as a power adapter or a battery device, and a power conversion module. The power conversion module converts power supplied by the power supply module and generates power to operate the electronic device 100.

At least one of the above-described components of the electronic device 100 may be included in the display device according to embodiments as described above. In addition, in terms of functionality, some of the individual modules included in one module may be included in the display device and others may be provided separately from the display device. For example, the display module 110 is included in the display device, whereas the processor 120, the memory 130, and the power module 140 are not included in the display device and are instead provided separately in the electronic device 100.

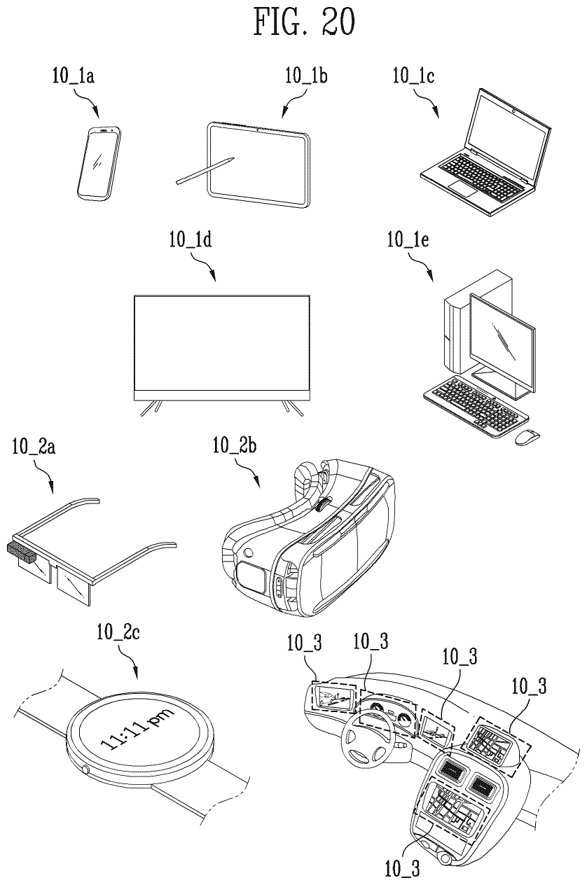

FIG. 20 shows schematic views of various embodiments of an electronic device.

Referring to FIG. 20, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A display device comprising:
a first scan driver comprising first scan stages dependently connected to each other and a first clock signal line connected to each of the first scan stages; and
a second scan driver comprising second scan stages dependently connected to each other and a second clock signal line connected to each of the second scan stages,
wherein a first circuit element constituting the first scan stages and a second circuit element constituting the second scan stages are positioned to overlap with each other, and
wherein the first clock signal line and the second clock signal line are positioned not to overlap with each other.

2. The display device of claim 1, wherein the first and second circuit elements are each positioned not to overlap with the first and second clock signal lines.

3. The display device of claim 1, wherein the second circuit element is on the first circuit element.

4. The display device of claim 3, wherein the first circuit element is implemented with a first circuit element layer comprising a first lower conductive layer, a first oxide semiconductor layer, a first gate conductive layer, and a first source-drain (SD) conductive layer, which are sequentially stacked on a substrate, and
wherein the second circuit element is implemented with a second circuit element layer comprising a second lower conductive layer, a second oxide semiconductor layer, a second gate conductive layer, and a second source-drain (SD) conductive layer, which are sequentially stacked on the first circuit element layer.

5. The display device of claim 4, further comprising a driving power line implemented with an intermediate circuit element layer, the intermediate circuit element layer comprising an intermediate conductive layer and being between the first circuit element layer and the second circuit element layer.

6. The display device of claim 5, wherein, on a section of the display device, the driving power line is between the first circuit element and the second circuit element.

7. The display device of claim 6, wherein the driving power line is electrically connected to the first circuit element and the second circuit element.

8. The display device of claim 5, wherein the first clock signal line comprises:
a first lower clock signal line implemented with the first SD conductive layer; and
a first upper clock signal line implemented with the intermediate conductive layer, the first upper clock signal line being connected to the first lower clock signal line, and
wherein the second clock signal line comprises:
a second lower clock signal line implemented with the intermediate conductive layer; and
a second upper clock signal line implemented with the second SD conductive layer.

9. The display device of claim 1, wherein the first clock signal and the second clock signal line are in a first line area, and
wherein the first scan stages and the second scan stages are in a first circuit element area adjacent to the first line area in a first direction.

10. The display device of claim 9, wherein the first line area comprises a (1-1)th line area and a (1-2)th line area adjacent to the (1-1)th line area in the first direction,
wherein the first clock signal line is in the (1-1)th line area, and
wherein the second clock signal line is in the (1-2)th line area.

11. The display device of claim 9, further comprising:
a third scan driver comprising third scan stages dependently connected to each other and a third clock signal line connected to each of the third scan stages; and
a fourth scan driver comprising fourth scan stages dependently connected to each other and a fourth clock signal line connected to each of the fourth scan stages.

12. The display device of claim 11, wherein a third circuit element constituting the third scan stages and a fourth circuit element constituting the fourth scan stages are positioned to overlap with each other, and
wherein the third clock signal line and the fourth clock signal line are positioned not to overlap with each other.

13. The display device of claim 12, wherein the third clock signal line and the fourth clock signal line are in a second line area adjacent to the first circuit element area in the first direction, and
wherein the third scan stages and the fourth scan stages are in a second circuit element area adjacent to the second line area in the first direction.

14. The display device of claim 13, wherein the second line area comprises a (2-1)th line area and a (2-2)th line area adjacent to the (2-1)th line area in the first direction,
wherein the third clock signal line is in the (2-1)th line area, and
wherein the fourth clock signal line is in the (2-2)th line area.

15. The display device of claim 1, further comprising a fifth scan driver comprising fifth scan stages dependently connected to each other and a fifth clock signal line connected to each of the fifth scan stages.

16. The display device of claim 15, wherein the fifth clock signal line is positioned not to overlap with the first and second clock signal lines and the first, second, and fifth scan stages.

17. The display device of claim 16, wherein the fifth scan stages are positioned not to overlap with the first and second clock signal lines and the first and second scan stages.

18. The display device of claim 15, wherein the fifth scan stages comprise a fifth lower circuit element and a fifth upper circuit element that overlap each other.

19. The display device of claim 18, wherein the fifth lower circuit element is implemented with a first circuit element layer comprising a first lower conductive layer, a first oxide semiconductor layer, a first gate conductive layer, and a first SD conductive layer, which are sequentially stacked on a substrate, and
wherein the fifth upper circuit element is implemented with a second circuit element layer comprising a second lower conductive layer, a second oxide semiconductor layer, a second gate conductive layer, and a second SD conductive layer, which are sequentially stacked on the first circuit element layer, and
the fifth upper circuit element and the fifth lower circuit element are electrically connected to each other.

20. An electronic device comprising:
a display device, wherein the display device comprises:
a first scan driver comprising first scan stages dependently connected to each other and a first clock signal line connected to each of the first scan stages; and
a second scan driver comprising second scan stages dependently connected to each other and a second clock signal line connected to each of the second scan stages,
wherein a first circuit element constituting the first scan stages and a second circuit element constituting the second scan stages are positioned to overlap with each other, and
wherein the first clock signal line and the second clock signal line are positioned not to overlap with each other.
